(19) United States
(12) Patent Application Publication
(10) Pub. No.: US 2024/0342586 A1
(43) Pub. Date: Oct. 17, 2024

(54) GAME SYSTEMS AND METHODS

(71) Applicant: The Upper Deck Company, Carlsbad, CA (US)

(72) Inventors: Ryan Miller, Huntsville, AL (US); Luke Peterschmidt, Lebanon, PA (US); David Freeman, Renton, WA (US)

(21) Appl. No.: 18/635,824

(22) Filed: Apr. 15, 2024

Related U.S. Application Data
(60) Provisional application No. 63/459,894, filed on Apr. 17, 2023.

(51) Int. Cl. A63F 1/04; A63F 1/00; A63F 13/537; A63F 13/822

(52) U.S. Cl. CPC A63F 1/04; A63F 13/537; A63F 13/822; A63F 2001/008; A63F 2001/0483

(57) ABSTRACT

A method can comprise a first player and an opponent conducting turns during a game. A first player's turn can include the first player activating cards and/or effectuating effects of one or more of the first player's active cards, playing active cards such as causing an active champion card to raid the opponent, and/or associating a number of victory points with a first player's raiding active champion card equal to the raiding active champion's raid value. The opponent's turn can include the opponent activating cards and/or effectuating effects of one or more of the opponent's active cards, and/or playing active cards such as causing an active opponent champion card to raid the first player or attack the first player's raiding active champion card. The victory points associated with the first player's raiding active champion card can be reduced by the raid value of an attacking opponent champion card.

### CROSS-REFERENCE TO RELATED APPLICATIONS

This application is a nonprovisional of, and claims priority to and the benefit of, U.S. Provisional Patent Application No. 63/459,894, filed Apr. 17, 2023 and entitled “GAME SYSTEMS AND METHODS,” which is hereby incorporated by reference herein.

### FIELD

The present disclosure relates generally to game systems and methods.

### BACKGROUND

It is a popular entertainment activity for individuals to play organized, instruction-based games, particularly games involving strategy, interacting and inter-related components, characters, and the like. There are, therefore, a wide variety of games employing various modes of play, components (e.g., cards, dice, game surfaces and boards, etc.), and degrees of strategy. Characters and other components of a game system can also be enjoyable for collecting purposes, with cards and other components having varying aesthetic components and degrees of rarity or desirability.

### SUMMARY

In various examples, a game system can be played by two opposing teams. Each team can have any suitable number of players (e.g., each team can have an equal number of players). In various examples, each team can comprise one to three players. The game system can comprise at least one original deck of cards and/or a game surface. Each player in the game system can comprise a separate original card deck. A card deck can comprise, for example, 20 to 60 action cards. Action cards can include at least one champion card, at least one location card, and/or at least one spell card. A card deck can further comprise at least one overlay card. An overlay card can be at least partially transparent and/or configured to be disposed over at least a portion of an action card (e.g., over a champion card). The overlay card can comprise at least one component that aligns with at least one component of the respective action card in response to being disposed over the respective action card. Each champion card in a card deck can have champion statistics associated therewith comprising a champion activation cost, a champion attack value, and/or a champion raid value. Each location card in a card deck can have a location activation cost and/or a location effect. A location effect can affect a status of a player's active champion card, a champion statistic of a player's active champion card, victory points collected by a player, and/or a number of cards in a player's hand. Each spell card in a card deck can have a spell activation cost and/or a spell effect. A spell effect can affect a status of a player's active champion card, a champion statistic of a player's active champion card, victory points collected by a player, and/or a number of cards a player's hand. The action card deck for each player can be disposed facedown on the game surface during gameplay.

In various examples, a method of gameplay can comprise a first player on a first team drawing a number of cards from the first player's card deck to create the first player's hand, and/or an opponent on an opposing team drawing a number of cards from the opponent's card deck to create the opponent's hand. The method can further comprise the first player presenting a player main character card comprising a player character effect and a player character power cost, and/or the opponent presenting an opponent main character card comprising an opponent character effect and an opponent character power cost.

The method can further comprise the first player conducting a first player turn of the game. The first player turn can comprise drawing a card from the first player's card deck into the first player's hand of cards, the first player adding an additional player influence card to a player influence zone of the game surface, determining a total number of player influence cards in the player influence zone, and/or conducting a player action phase. Adding an additional player influence card can comprise the first player drawing the additional player influence card from the first player's card deck and disposing the additional player influence card facedown in the first player's influence zone.

Conducting a player action phase can comprise the first player activating at least one card from the player hand by disposing such card(s) from the player hand onto the game surface; playing an active player card that was activated in a previous turn, wherein the active card comprises an active player champion, and wherein playing the active player champion comprises causing the active player champion to raid an opponent; disposing a number of victory points on the raiding active player champion equal to the champion raid value for the raiding active player champion; and/or disposing the raiding active player champion in an exhausted position to indicate an exhausted status. In various examples, activating at least one card from the player hand can comprise activating a player champion card (wherein the player champion card can comprise a player champion activation cost indicating a required number of influence cards to activate the player champion card), activating a player location card (wherein the player location card can comprise a player location activation cost indicating a required number of influence cards to activate the player location card), and/or activating a player spell card (wherein the player spell card can comprise a player spell activation cost indicating a required number of influence cards to activate the player spell card). A total of the player champion activation cost, the player location activation cost, and/or the player spell activation cost can be equal to or less than the total number of player influence cards in the player influence zone. That is, the total number of player influence cards in the player influence zone can cover the activation costs of all activated cards by the first player.

In various examples, activating at least one card from the player hand can comprise, in response to the total number of player influence cards in the player influence zone being greater than or equal to the sum of a player champion activation cost and a player location activation cost, activating the respective player champion card and the respective player location card. In various examples, activating at least one card from the player hand can comprise, in response to the total number of player influence cards in the player influence zone being greater than or equal to the sum of a player champion activation cost, a player location activation cost, and a player spell activation cost, activating the respective player champion card, the respective player location card, and the respective player spell card. In various examples, the method can further comprise the first player disposing the number of player influence cards equal to the total of the player champion activation cost, the player location activation cost, and/or the player spell activation cost into the exhausted position to indicate the exhausted status in response to the activating at least one card from the player hand.

In various examples, activating at least one card from the player hand can comprise activating a player overlay card from the player hand, and/or disposing the player overlay card on the active player champion. The player overlay card can increase at least one of the champion attack value or the champion raid value of the active player champion. The player overlay card can comprise an overlay value, wherein each champion card comprises a statistic comprising an overlay allowance, wherein the overlay value of the player overlay card disposed on the active player champion is less than or equal to a player overlay allowance of the active player champion.

In various examples, conducting the player action phase can comprise the first player playing an active player card comprising an active player location card, effectuating the location effect of the active player location card, and/or disposing the active player location card in the exhausted position to indicate the exhausted status. In various examples, conducting the player action phase can comprise the first player playing the first player's main character effect, effectuating the player main character effect, and/or disposing the player main character card in the exhausted position to indicate the exhausted status.

The method can further comprise the opponent conducting a first opponent turn. The first opponent turn can comprise drawing a card from the opponent's card deck into the opponent's hand of cards, the opponent adding an opponent influence card to an opponent influence zone of the game surface, determining a total number of opponent influence cards in the opponent influence zone, and/or conducting an opponent action phase.

Conducting an opponent action phase can comprise the opponent activating at least one card from the opponent's hand by disposing such card(s) from the opponent's hand onto the game surface; playing an active opponent card that was activated in a previous turn, wherein the active card comprises an active opponent champion; and/or disposing the active opponent champion in the exhausted position to indicate the exhausted status. Playing the active opponent champion can comprise at least one of causing the active opponent champion to raid the first player or attack the raiding active player champion. Activating at least one card from the opponent's hand can comprise activating an opponent champion card (wherein the opponent champion card can comprise an opponent champion activation cost indicating a required number of influence cards to activate the opponent champion card), activating an opponent location card (wherein the opponent location card can comprise an opponent location activation cost indicating a required number of influence cards to activate the opponent location card), and/or activating an opponent spell card (wherein the opponent spell card can comprise an opponent spell activation cost indicating a required number of influence cards to activate the opponent spell card). A total of at least one of the opponent champion activation cost, the opponent location activation cost, and the opponent spell activation cost can be equal to or less than the total number of opponent influence cards in the opponent influence zone. That is, the total number of opponent influence cards in the opponent influence zone can cover the activation costs of all activated cards by the opponent.

In various examples, the method can further comprise the first team (e.g., the first player on the first team) conducting a second player turn, including readying the active player champion by disposing the active player champion from the exhausted position to a ready position to indicate a ready status. In various examples, the method can further comprise the first player collecting the victory points disposed on the active player champion in response to readying the active player champion during the second player turn. In various examples, wherein playing the active opponent champion comprises attacking the raiding active player champion, the first opponent turn can further comprise removing victory points from the raiding active player champion equal to the champion raid value of the attacking active opponent champion, comparing the champion attack value of the attacking active opponent champion with the champion attack value of the raiding active player champion, and/or in response to the champion attack value of the attacking active opponent champion being lower than the champion attack value of the raiding active player champion, discarding the attacking active opponent champion, or in response to the champion attack value of the attacking active opponent champion being greater than the champion attack value of the raiding active player champion, discarding the raiding active player champion. In various examples, the method can further comprise the first player collecting the remaining victory points disposed on the active player champion after removing the victory points from the raiding active player champion equal to the champion raid value of the attacking active opponent champion in response to readying the active player champion during the second player turn. As part of the second player turn, the first player can ready the active player location by disposing the active player location from the exhausted position to the ready position to indicate the ready status.

In various examples, playing the active opponent champion can comprise causing the active opponent champion to raid the first player. The method can further comprise disposing a number of victory points on the raiding active opponent champion equal to the champion raid value for the raiding active opponent champion.

In various examples, conducting the first opponent turn can further comprise the opponent playing an active opponent card comprising an active opponent spell, wherein the spell effect of the active opponent spell can cause readying of the active player champion to occur before the conducting the second player turn, and/or in response, the victory points disposed on the active player champion can be discarded.

In various examples, the first team can comprise at least two players, and the opposing team can comprise a number of opponents equal to the players on the first team. Each player on the player team can conduct a respective first player turn simultaneously, and each opponent of the opposing team can conduct a respective first opponent turn simultaneously.

A system, method, and article of manufacture (collectively, “the system”) are disclosed relating to game systems and methods. In various examples, the system can comprise a user device comprising a display screen, a processor operably connected to the user device, and/or a tangible non-transitory computer readable memory configured to communicate with the processor, the tangible non-transitory computer readable memory having instructions stored thereon that, in response to execution by the processor causes the processor to perform operations. The system can be configured to perform operations including drawing, by the processor and a random number generator, a number of player digital cards from a first player's digital card deck to create a player digital hand for the first player, presenting, by the processor, the player digital cards on a graphical user interface (GUI) for the player digital hand, and/or drawing, by the processor and the random number generator, a number of opponent digital cards from an opponent's digital card deck to create an opponent digital hand for the opponent. The operations can further comprise presenting, by the processor, a player digital main character card on the GUI, wherein the player digital main character card comprises a player main character effect and a player main character power cost; presenting, by the processor, an opponent digital main character card on the GUI, wherein the opponent digital main character card comprises an opponent main character effect and an opponent main character power cost; and/or conducting, by the processor, a first player turn of a game for the first player on a first team.

Conducting the first player turn can comprise drawing, by the processor and a random number generator, a digital card from the first player's digital card deck and presenting the drawn digital card as part of the first player's digital hand on the GUI (the player digital card deck can be presented facedown on the GUI); presenting, by the processor and the random number generator, an additional player digital influence card facedown from the first player's digital card deck in a player influence zone of the GUI; determining, by the processor, a total number of player digital influence cards in the player influence zone including the additional player digital influence card; and/or conducting, by the processor, a player action phase.

In various examples, conducting the player action phase can comprise receiving, by the processor, a selection of at least one digital card from the first player's digital hand to activate; activating, by the processor, the selected digital card(s) by removing the selected digital card(s) from the first player's digital hand and presenting the selected digital card(s) faceup on the GUI; receiving, by the processor, a selection of an active player digital card presented on the GUI that was activated in a previous turn; playing, by the processor, the selected active player digital card, wherein the selected active player digital card can comprise an active player digital champion, and wherein playing the active player digital champion can comprise causing the active player digital champion to raid the opponent; associating, by the processor, a number of victory points with the raiding active player digital champion equal to the champion raid value for the raiding active player digital champion; and/or disposing, by the processor, the raiding active player digital champion in an exhausted position on the GUI to indicate an exhausted status.

In various examples, activating at least one digital card can comprise activating, by the processor, a player digital champion card, wherein the player digital champion card comprises a player champion activation cost indicating a required number of digital influence cards to activate the player digital champion card; activating, by the processor, a player digital location card, wherein the player digital location card comprises a player location activation cost indicating a required number of digital influence cards to activate the player digital location card; and/or activating, by the processor, a player digital spell card, wherein the player digital spell card comprises a player spell activation cost indicating a required number of digital influence cards to activate the player digital spell card. The processor can confirm that a total of at least one of the player champion activation cost, the player location activation cost, and the player spell activation cost is equal to or less than the total number of player digital influence cards in the player influence zone in order to perform the activating the at least one digital card.

In various examples, the operations can further comprise conducting, by the processor, a first opponent turn of the game for the opponent. Conducting the first opponent turn can comprise drawing, by the processor and the random number generator, a digital card from the opponent's digital card deck and presenting the drawn digital card as part of the opponent's digital hand, wherein the opponent digital card deck is presented facedown on the GUI; presenting, by the processor and the random number generator, an additional opponent digital influence card facedown from the opponent digital card deck in an opponent influence zone of the GUI; determining, by the processor, a total number of opponent digital influence cards in the opponent influence zone including the additional opponent digital influence card; and/or conducting, by the processor, an opponent action phase.

In various examples, a digital card deck (e.g., the first player's digital card deck and/or the opponent's digital card deck) can comprise, for example, 20 to 60 digital cards including at least one digital champion card, at least one digital location card, and at least one digital spell card. The player digital card deck can further comprise at least one digital overlay card, wherein the digital overlay card is at least partially transparent and is configured to be disposed over at least a portion of at least one digital action card (e.g., a digital champion card). The digital overlay card can comprise at least one component that aligns with at least one component of the respective digital action card in response to being disposed over the respective digital action card. Each digital champion card can have champion statistics associated therewith comprising a champion activation cost, a champion attack value, and/or a champion raid value. Each digital location card can comprise a location activation cost and/or a location effect. The location effect can affect at least one of a status of an active digital champion card of the first player or the opponent, a champion statistic of an active digital champion card of the first player or the opponent, victory points associated with the first player or the opponent, and/or a number of digital cards in the first player's digital hand or the opponent's digital hand. Each digital spell card of the at least one digital spell card can comprise a spell activation cost and/or a spell effect. The spell effect can affect at least one of the status of an active digital champion card of the first player or the opponent, a champion statistic of an active digital champion card of the first player or the opponent, victory points associated with the first player or the opponent, or a number of digital cards in the first player's digital hand or the opponent's digital hand.

In various examples, conducting the opponent action phase can comprise receiving, by the processor, a selection of at least one digital card from the opponent's digital hand to activate; activating, by the processor, the selected digital card by presenting the selected digital card from the opponent's digital hand faceup on the GUI; receiving, by the processor, a selection of an active opponent digital card presented on the GUI that was activated in a previous turn; playing, by the processor, the active opponent digital card, wherein the active opponent digital card comprises an active opponent digital champion, and wherein playing the active player opponent champion comprises at least one of causing, by the processor, the active opponent champion to raid the first player or attack the raiding active player digital champion; and/or disposing, by the processor, the active opponent digital champion in the exhausted position to indicate the exhausted status.

In various examples, activating at least one digital card from the opponent digital hand can comprise activating, by the processor, an opponent digital champion card, wherein the opponent digital champion card comprises an opponent champion activation cost indicating a required number of digital influence cards to activate the opponent digital champion card; activating, by the processor, an opponent digital location card, wherein the opponent digital location card comprises an opponent location activation cost indicating a required number of digital influence cards to activate the opponent digital location card; and/or activating, by the processor, an opponent digital spell card, wherein the opponent digital spell card comprises an opponent spell activation cost indicating a required number of digital influence cards to activate the opponent digital spell card. The processor can confirm that a total of the opponent champion activation cost, the opponent location activation cost, and/or the opponent spell activation cost is equal to or less than the total number of opponent digital influence cards in the opponent influence zone in order to activate the selected digital card(s).

In various examples, the operations can further comprise conducting, by the processor, a second player turn of the game. The second player turn can comprise readying, by the processor, the active player digital champion by disposing the active player digital champion from the exhausted position to a ready position on the GUI to indicate a ready status. The operations can further comprise assigning, by the processor, the victory points associated with the active player digital champion to the first player in response to readying the active player digital champion during the second player turn.

### BRIEF DESCRIPTION OF THE DRAWINGS

The subject matter of the present disclosure is particularly pointed out and distinctly claimed in the concluding portion of the specification. A more complete understanding of the present disclosure, however, can best be obtained by referring to the detailed description and claims when considered in connection with the drawing figures. In the figures, like referenced numerals can refer to like parts throughout the different figures unless otherwise specified.

FIG. 1 illustrates a schematic diagram of a game system, in accordance with various examples.

FIG. 2 illustrates a schematic diagram of a game surface for a game system, in accordance with various examples.

FIG. 3 illustrates an original deck of cards for a game, in accordance with various examples.

FIG. 4 illustrates an exemplary main character card for inclusion in an original deck of cards for a game, in accordance with various examples.

FIG. 5 illustrates an exemplary champion card for inclusion in an original deck of cards for a game, in accordance with various examples.

FIG. 6 illustrates another exemplary champion card for inclusion in an original deck of cards for a game, in accordance with various examples.

FIG. 7A illustrates an exemplary overlay card for inclusion in an original deck of cards for a game, in accordance with various examples.

FIG. 7B illustrates the overlay card of FIG. 7A applied to the champion card of FIG. 5 for a game, in accordance with various examples.

FIG. 8 illustrates an exemplary location card for inclusion in an original deck of cards for a game, in accordance with various examples.

FIG. 9 illustrates an exemplary spell card for inclusion in an original deck of cards for a game, in accordance with various examples.

FIG. 10 illustrates a flowchart of an exemplary method for playing a game system, in accordance with various examples.

FIG. 11 illustrates a flowchart of an exemplary method for conducting an action phase during a game, in accordance with various examples.

FIG. 12 illustrates a schematic diagram of an electronic or digital game system, in accordance with various examples.

FIG. 13 illustrates a graphical user interface for an electronic or digital game system, in accordance with various examples.

FIG. 14 illustrates a flowchart of an exemplary method for playing a digital game system, in accordance with various examples.

FIG. 15 illustrates a flowchart of an exemplary method for conducting an action phase during a digital game, in accordance with various examples.

### DETAILED DESCRIPTION

The detailed description of various examples herein makes reference to the accompanying drawings, which show the various examples by way of illustration. While these various examples are described in sufficient detail to enable those skilled in the art to practice the disclosure, it should be understood that other examples can be realized and that logical, electronic, compositional, and mechanical changes can be made without departing from the spirit and scope of the disclosure. Thus, the detailed description herein is presented for purposes of illustration only and not of limitation. For example, the steps recited in any of the method or process descriptions can be executed in any combination or order and are not limited to the combination and order presented. Moreover, any of the functions or steps can comprise intervening steps therebetween and/or can be outsourced to or performed by one or more third parties. Furthermore, any reference to singular includes plural examples, and any reference to more than one component or step can include a singular component or step. Denotations such as “first,” “second,” and/or the like do not necessarily or directly indicate a certain order or sequence, but can function as identifiers to identify discrete aspects, and/or associate certain aspects, of a system or method, as dictated by the context in which such denotations are used. Any reference to attached, fixed, connected, or the like can include permanent, removable, temporary, partial, full, and/or any other possible attachment option.

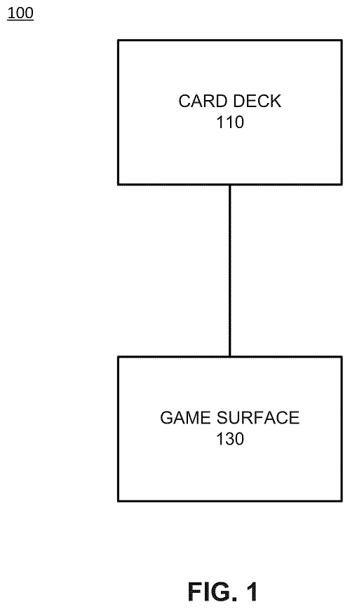

With reference to FIG. 1, a block diagram of an exemplary game system 100 is depicted, in accordance with various examples. In various embodiments, game system 100 can comprise a card deck 110 and/or a game board or surface 130. The components of game system 100 (e.g., various card types within card deck 110) can interact with one another to determine game actions, scoring, and/or the like. For example, cards in card deck 110, and/or information or images displayed thereon, can dictate related cards to play, actions to take, victory points to receive or lose, statuses of cards, and/or spaces on a game surface 130 upon which to take certain actions within a game.

In various examples, card deck 110 can comprise an original card deck having various card types. Cards in the original card deck can comprise any suitable shape (e.g., rectangular, square, oval, and/or the like) and any suitable material (e.g., the cards can be made of paper, cardboard, a polymeric material (e.g., a plastic), a ceramic, a metallic material, and/or the like).

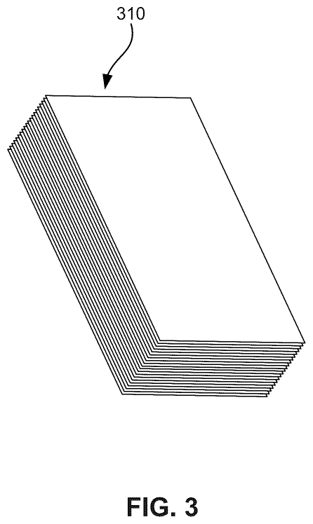

In various examples, a card deck 310 shown in FIG. 3 (an example of card deck 110 in FIG. 1) can comprise action cards that comprise certain characters (e.g., champions), locations, spells, and their associated statistics, characteristics, and/or effects that instruct certain actions or cause effects in response to a card being activated or played during gameplay of game system 100. In various examples, card deck 310 can comprise 20-60 action cards, 30-50 action cards, about 30 action cards, about 40 action cards, or about 50 action cards, (in this context, “about” means plus or minus five cards). There may be a card deck limit, indicating a maximum number of cards in a card deck 310, which can be any of the foregoing numbers of cards, or any other suitable number. Card deck 310 can comprise various types of action cards for game system 100. In various examples, an action card can comprise a champion card, a location card, and/or a spell card. In various examples, card deck 310 can comprise at least one champion card, at least one location card, and/or at least one spell card. Each player of game system 100 can have their own original card deck or a portion thereof.

In various examples, a card deck 310 can comprise one or more main character cards, which can also be referred to as avatar cards. Each main character card can comprise a main character or avatar (e.g., a picture and/or title thereof) and/or various characteristics or statistics of the respective main character. For example, each main character can have a main character species, a main character effect, and/or a power cost. The main character species can dictate which cards can be used with the respective main character. Accordingly, a card deck can comprise cards having a card species that matches or is associated with the main character species of a main character card. In various examples, a player of game system 100 can select a main character card and build a card deck 310 around the selected main character (with cards of the same type as the respective main character species). One copy of the selected main character card may not be counted as part of the card deck limit of cards in a card deck. Duplicates of the main character card, discussed further herein, can be counted as part of the card deck limit of cards in a card deck.

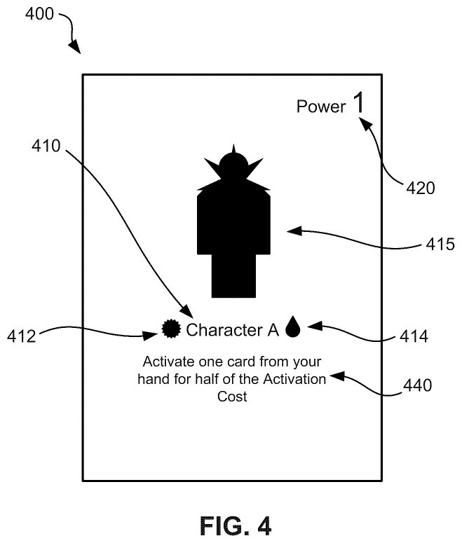

With additional reference to FIG. 4, main character card 400 is an example of a main character card included in card deck 310. Main character card 400 can comprise the character title or name 410 and/or character image 415 to identify the associated character. Main character card 400 can comprise main character species 412, 414. That is, main character card 400 can comprise two main character species, e.g., sun or fire species 412 and rain or water species 414. Thus, the cards in the card deck having main character card 400 can comprise card species of sun/fire and/or rain/water. Main character card 400 can comprise main character effect 440. A main character effect can have any desired effect on the game (e.g., the main character effect can indicate an action to take by one or more players and/or can affect an action, play, or turn). For example, a main character effect can have an effect on a player or team's cards and/or their characteristics, statistics, or statuses (whether in the player's hand, or active on the game surface), victory points collected by a player or team, a number of cards in a player's hand, and/or the like. As shown in FIG. 4, main character effect 440 allows the respective player to activate a card from the player's hand (i.e., dispose the card from the player's hand on the game surface to allow utilization of the respective card and taking any respective action during a game) for half of the activation cost of the respective card (discussed further herein).

In various examples, main character card 400 can comprise main character power cost 420. In various examples, in order for a main character to effectuate its main character effect (i.e., in order for a player to utilize or play the main character effect), the main character may require a certain amount of power. The power of a main character can be indicated by objects (e.g., marbles, chips, tokens, or the like) being placed on or proximate the main character card. In response to sufficient power being associated with the main character (e.g., objects indicating power equaling or greater than the main character's power cost), the main character's effect can be effectuated. In response, the main character's power can be removed and the main character can be exhausted (e.g., making the main character effect unavailable until a certain event occurs, such as regaining sufficient power), the main character card can be placed in a position or orientation to indicate exhaustion, such as horizontally or at an angle (e.g., a nonparallel, nonorthogonal angle) relative to an edge of the game surface (e.g., the game surface edge proximate to the respective player), facedown, and/or the like. In response to being exhausted, the power cost amount of power can be removed from the main character card.

A main character can regain the power required to effectuate the main character effect after exhaustion in any suitable manner. For example, a player may wait a required or predetermined number of turns before the main character has enough power to use the main character effect again. Each turn, a main character can generate a certain amount of power (e.g., one power per turn). In various examples, a card deck 310 can comprise multiple copies of the same main character card (i.e., duplicate copies). In response to the player drawing a duplicate of active main character card, the player can play the duplicate main character card to gain a certain amount of power (e.g., one power for each duplicate main character card). A used duplicate main character card can be discarded in response to generating power for the active main character card. Playing duplicate main character cards to gain power for the active main character can allow a player to utilize the main character effect sooner than waiting a required number of turns or the number of turns needed to generate sufficient power to meet the main character's power cost.

The statistics, characteristics, or other information of a main character can be disposed in any suitable location on the main character card. As shown on main character card 400, power cost 420 can be disposed proximate and/or adjacent to a top edge of the respective main character card. The character image or symbol 415 can be disposed approximately in the middle of a main character card (e.g., between a top edge of the card and the main character effect). A character title name 410 can be disposed under a character image or symbol 415. The main character effect 440 can be disposed proximate a bottom edge of the main character card (e.g., the component of a main character card most proximate a bottom edge of the main character card). As used herein, “main character” can refer to the main character and/or the respective main character card.

In various examples, a card deck 310 can comprise one or more champion cards. Each champion card can comprise a champion (e.g., a picture and/or title thereof) and/or various characteristics or statistics of the respective champion. For example, each champion card can have statistics including a champion activation cost, a champion attack value, a champion raid value, a champion species, a champion overlay allowance, and/or a champion effect. The champion species can dictate which cards can be used with the respective champion and/or which champions can be associated with which main character. For example, champions in a card deck can have a matching card species to the main character species of the main character card comprised in the deck.

In various examples, a champion activation cost can be the number of influence cards (discussed further herein) required to activate the respective champion. As used herein, “activate” can mean moving a respective card from a player's hand onto the game surface to allow utilization of the respective card and taking actions related to the respective card during a game (whether during a present or subsequent turn). A champion attack value can be the strength of a champion when attacking an opponent's champion (an opponent's raiding champion, as discussed further herein). A champion raid value can be the number of victory points received by a raiding champion, as discussed further herein. A champion overlay allowance can be an indicator of what types of overlay cards are available for use with a respective champion. For example, a champion card can only receive an overlay card that has an overlay value that is less than or equal to the champion overlay allowance of the respective champion.

A champion effect can have any desired effect on the game (e.g., the champion effect can indicate an action to take by one or more players and/or affect an action, play, or turn). For example, a champion effect can have an effect on a player or team's cards and/or their characteristics, statistics, or statuses (whether in the player's hand, or active on the game surface, or in an exhausted or readied status), victory points collected by a player or team, a number of cards in a player's hand, and/or the like.

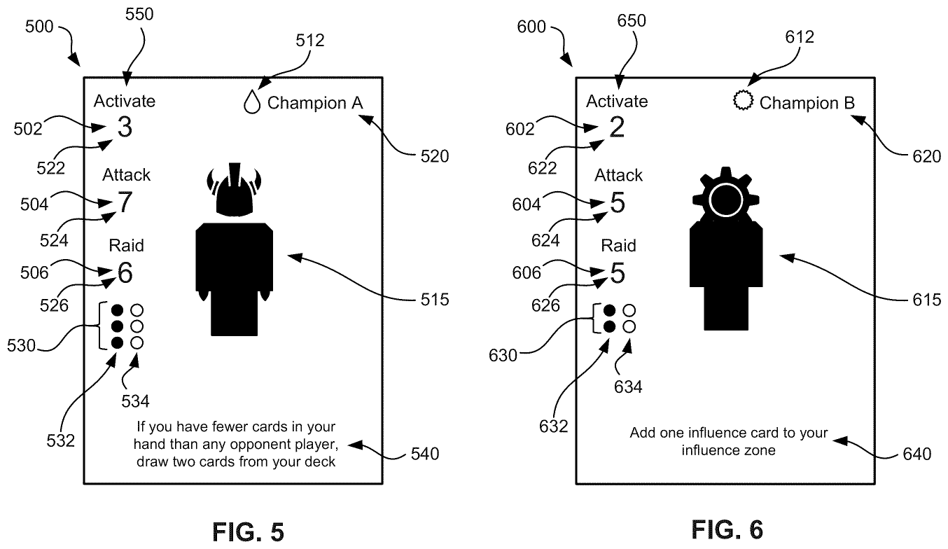

With additional reference to FIGS. 5 and 6, champion cards 500, 600 are examples of champion cards included in card deck 310. Champion card 500 can comprise the champion title or name 520 and/or champion image 515 to identify the associated champion. Champion card 500 can comprise champion species 512. Champion species 512 can match one of main character species 412, 414 (e.g., matching the rain/water species in this example). Champion card 500 can comprise champion effect 540. A champion effect can have any desired effect on the game (e.g., the champion effect can indicate an action to take by one or more players and/or affecting an action, play, or turn). As shown in FIG. 5, champion effect 540 allows the respective player to draw two cards from card deck 310 in response to having fewer cards in the player's hand than an opponent player (i.e., an opponent on an opposing team). Champion card 500 can further comprise a champion activation cost of 3, a champion attack value of 7, and a champion raid value of 6.

As another example of a champion card, champion card 600 can comprise the champion title or name 620 and/or champion image 615 to identify the associated champion. Champion card 600 can comprise champion species 612. Champion species 612 can match one of main character species 412, 414 (e.g., matching the sun/fire species in this example). Champion card 600 can comprise champion effect 640. As shown in FIG. 6, champion effect 640 allows the respective player to add an influence card to the player's influence zone. Champion card 600 can further comprise a champion activation cost of 2, a champion attack value of 5, and a champion raid value of 5.

The statistics, characteristics, or other information of a champion can be disposed in any suitable location on the champion card. As shown on champion cards 500, 600, the champion name/title can be disposed proximate and/or adjacent to a top edge of the respective champion card. The champion image or symbol 515, 615 can be disposed approximately in the middle of a champion card (e.g., between the champion title/name and the champion effect). The champion effect 540 can be disposed proximate a bottom edge of the champion card (e.g., the component of a champion card most proximate a bottom edge of the champion card). The statistics or other information of a champion can be disposed in any suitable location on the champion card. As shown on champion cards 500 and 600, champion activation costs 522 and 622, champion attack values 524 and 624, and champion raid values 526 and 626 can be disposed in a value or statistics section 550 and 650, respectively, which can be disposed along and/or proximate a side edge of the respective champion card (e.g., along a left edge). A statistics section on a champion card can have various positions for different values or statistics. For example, champion card 500 can comprise first value position 502, second value position 504, and/or third value position 506. Champion activation cost 522 can be disposed in first value position 502, champion attack value 524 can be disposed in second value position 504, and champion raid value 526 can be disposed in second value third position 506. As another example, champion card 600 can comprise first value position 602, second value position 604, and/or third value position 606. Champion activation cost 622 can be disposed in first value position 602, champion attack value 624 can be disposed in second value position 604, and champion raid value 626 can be disposed in third value position 606.

In various examples, a champion card can comprise an overlay allowance. As discussed herein, a champion overlay allowance can be an indicator of what types of overlay cards are available for use with a respective champion. For example, champion card 500 comprises overlay section 530 having an overlay allowance 532 of three (3) (represented by the three darkened dots on champion card 500). Thus, overlay cards in the player's card deck 310 that comprise an overlay value of three or less can be used with champion card 500 (indicated by overlay spaces 534 configured to receive or align with the overlay value on an appropriate overlay card). As another example, champion card 600 comprises overlay section 630 having an overlay allowance 632 of two (2) (represented by the two darkened dots on champion card 600). Thus, overlay cards in the player's card deck 310 that comprise an overlay value of two or less can be used with champion card 600 (indicated by overlay spaces 634 configured to receive or align with the overlay value on an appropriate overlay card).

In various examples, a card deck 310 can comprise one or more overlay cards. Each overlay card can comprise various characteristics or statistics of the respective overlay. For example, each overlay card can have an overlay activation cost, an overlay value, an overlay species, and/or an overlay effect. The overlay species can dictate which cards can be used with the respective overlay card and/or which champions or locations can be associated with which overlay cards. For example, overlay cards in a card deck can have a matching card species to a champion species, and accordingly, such overlay cards can be used with the respective champion.

In various examples, an overlay activation cost can be the number of influence cards (discussed further herein) required to activate the respective overlay card. An overlay value can indicate the champion overlay allowance of a champion card required for the respective overlay card to be played or associated with the respective champion card, or the location overlay allowance of a location card required for the respective overlay card to be played or associated with the respective location card. An overlay effect can have any desired effect on the game (e.g., the overlay effect can indicate an action to take by one or more players and/or affecting an action, play, or turn). For example, an overlay effect can have an effect on a player or team's cards and/or their characteristics, statistics, or statuses (whether in the player's hand, or active on the game surface), victory points collected by a player or team, a number of cards in a player's hand, and/or the like. In various examples, an overlay card can only be played in conjunction with another card from the card deck, such that the overlay card will be associated with such other card, such as a champion card or location card.

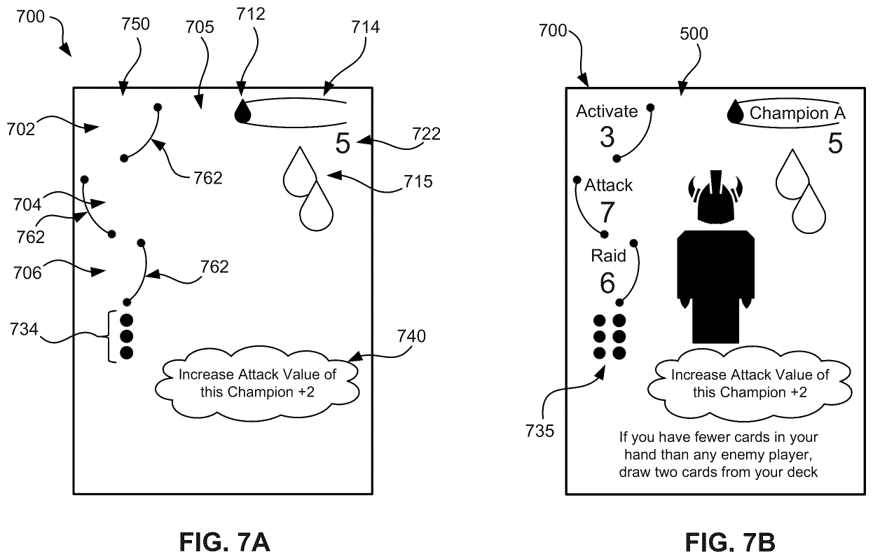

With additional reference to FIG. 7A, overlay card 700 is an example of an overlay card included in card deck 310. Overlay card 700 can comprise overlay species 712 (e.g., rain/water species). Overlay species 712 can match one of main character species 412, 414 (e.g., matching the rain/water species in this example) and/or the champion species of champion cards in the card deck 310 (e.g., the champion species of champion card 500). The overlay species can be indicated in title frame 714, configured to associate with the name/title of the associated champion or location card. Overlay card 700 can comprise an overlay image or symbol 715 to identify the associated overlay. Overlay card 700 can comprise overlay effect 740. As shown in FIG. 7A, overlay effect 740 affects the statistic(s) of the champion or location card with which the overlay card is played and associated. Specifically, overlay card 700 increases the attack value of the associated champion card by two (+2). Overlay card 700 can comprise an overlay activation cost 722 of 5, an overlay value 734 of 3 (indicated by the three dots), and/or statistic frames 762. Statistic frames 762 can be disposed in a statistics section 750. A statistics section on an overlay card can have various positions to align with various values or statistics on a champion or location card. For example, overlay card 700 can comprise first statistic position 702, second statistic position 704, and/or third statistic position 706.

In various examples, an overlay card can be configured to be disposed on top of or over a champion or location card with which the overlay card will be played or associated. An overlay card can comprise a card body 705 that is at least partially transparent. Card body 705 can be at least partially clear (i.e., transparent) and colorless, and/or can have a color associated therewith. Card body 705 can be made from or comprise a polymeric material (e.g., plastic) to allow such transparency. The components of an overlay card can be disposed complementary to the champion or location card with which the overlay may associate. For example, the components of overlay card 700 can be arranged complementary to the components of champion card 500, with which overlay card 700 can be associated, and/or over which overlay card 700 can be disposed.

As shown in FIG. 7B, overlay card 700 is disposed over champion card 500 from FIG. 5. The components of overlay card 700 are arranged complementary to the components of champion card 500. Title frame 714 of overlay card 700 can be associated with (e.g., partially surround) title 520 of champion card 500. The overlay species 712 in title frame 714 can overlap with champion species 512 of champion card 500 in response to overlay card 700 being disposed over champion card 500. Overlay value 734 of overlay card 700 can align with overlay allowance 532 of champion card 500, such that overlay spaces 534 on champion card 500 are covered or filled in by the overlay value 734 of overlay card 700 in response to overlay card 700 being disposed over champion card 500. Accordingly, overlay status 735 depicting the champion's overlay allowance and the overlay card's overlay value can be viewed. Overlay effect 740 of overlay card 700 can be aligned with a blank portion of champion card 500 (e.g., the blank portion between champion image 515 and champion effect 540). In various examples, the overlay effect may comprise a portion of the overlay card that is at least partially opaque that covers at least a portion of the champion effect in response to the overlay card being disposed over the champion card, thus replacing the champion effect with the overlay effect (which may be better or more favorable to the respective player). In various examples, the overlay effect can cover at least a portion of any other component of the champion card (e.g., at least a portion of champion image 515) in response to the overlay card being disposed over the champion card. Statistics section 750 of overlay card 700 can align with statistics section 550 of champion card 500 in response to overlay card 700 being disposed over champion card 500. Thus, first statistic position 702, second statistic position 704, and third statistic position 706 of overlay card 700 can be aligned with first value position 502, second value position 504, and/or third value position 506 of champion card 500, respectively. Statistic frames 762 of overlay card 700 can be disposed around each statistic of champion card 500 (e.g., which helps with alignment of the two cards, but also can have a desired aesthetic effect). In various examples, the statistics section 750 of overlay card 700 may comprise a portion of the overlay card that is at least partially opaque and covers the respective value section of the champion card 500 in response to the overlay card being disposed over the champion card. Thus, the opaque portion of the overlay card 700 can comprise an upgraded statistic thereon that covers and replaces the respective statistic of champion card 500 (which may be better or more favorable to the respective player).

In various examples, there can be an overlay limit of the number of overlay cards that can be disposed over or associated with another card (e.g., a champion or location card). For example, only one overlay card may be allowed to be played or associated with another card. To play another overlay card and associate it with a card that already has an overlay card associated therewith, the player can discard the previously-played overlay card and replace it with the new one.

In various examples, overlay cards can count toward a card limit for a card deck. In various examples, overlay cards included in a card deck may not contribute to the card limit of a card deck. That is, if a card deck is limited to about 40 cards, for example, overlay cards included in the deck may not count toward the 40-card limit. In various examples, there can be an overlay limit of overlay cards within a card deck. For example, the overlay limit can be a maximum number of overlay cards (e.g., ten). As another example, the overlay limit can be a limit determined by overlay card statistics. For example, an overlay limit can be set as a maximum total overlay value of all overlay cards. For example, the overlay limit can mean that the sum total overlay values, and/or the sum total overlay activation costs, of all overlay cards cannot exceed a predetermined value, for example, about 30 (“about” meaning plus or minus five).

In various examples, a card deck 310 can comprise one or more location cards. Each location card can comprise a location (e.g., a picture and/or title thereof) and/or various characteristics or statistics of the respective location. For example, each location card can have statistics including a location activation cost, a location species, and/or a location effect. The location species can dictate which cards can be used with the respective location and/or which locations can be associated with which main character. For example, locations in a card deck can have a matching card species to the main character species of the main character card comprised in the deck. In various examples, a location card can comprise a location overlay allowance (similar to a champion overlay allowance), which can indicate what types of overlay cards are available for use with a respective location. For example, a location card can only receive an overlay card that has an overlay value that is less than or equal to the location overlay allowance of the respective location.

In various examples, a location activation cost can be the number of influence cards (discussed further herein) required to activate the respective location. A location effect can have any desired effect on the game (e.g., the location effect can indicate an action to take by one or more players and/or affect an action, play, or turn). For example, a location effect can have an effect on a player or team's cards and/or their characteristics, statistics, or statuses (whether in the player's hand, or active on the game surface), victory points collected by a player or team, a number of cards in a player's hand, and/or the like.

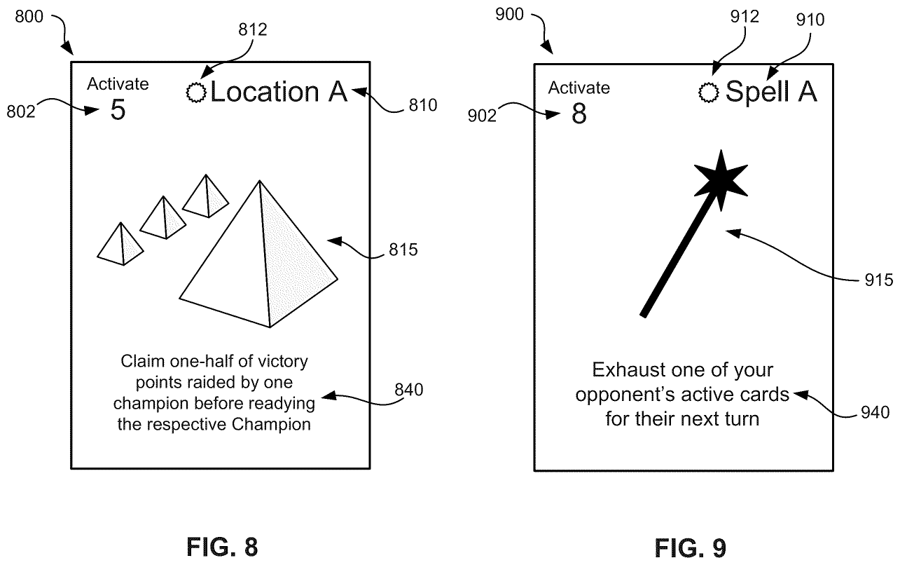

With additional reference to FIG. 8, location card 800 is an example of location cards included in card deck 310. Location card 800 can comprise the location title or name 810 and/or location image 815 to identify the associated location. Location card 800 can comprise location species 812. Location species 812 can match one of main character species 412, 414 (e.g., matching the sun/fire species in this example). Location card 800 can comprise location effect 840. As shown in FIG. 8, location effect 840 allows the respective player to claim one-half of victory points raided by a raiding champion in a turn before readying the respective champion at the beginning of a subsequent turn (discussed further herein) (typically, the victory points from a raiding champion can be claimed after the opposing team's subsequent turn to give the opposing team a chance to defend and take back raided victory points). Location card 800 can comprise a location activation cost 802 of 5.

The statistics, characteristics, or other information of a location can be disposed in any suitable location on the location card. As shown on location card 800, the location name/title can be disposed proximate and/or adjacent to a top edge of the respective location card. The location image or symbol 815 can be disposed approximately in the middle of a location card (e.g., between the location title/name and the location effect). The location effect 840 can be disposed proximate a bottom edge of the location card (e.g., the component of a location card most proximate a bottom edge of the location card).

In various examples, a card deck 310 can comprise one or more spell cards. Each spell card can comprise a spell (e.g., a picture and/or title thereof) and/or various characteristics or statistics of the respective spell. For example, each spell card can have a spell activation cost, a spell species, and/or a spell effect. The spell species can dictate which cards can be used with the respective spell and/or which spells can be associated with which main character. For example, spells in a card deck can have a matching card species to the main character species of the main character card comprised in the deck.

In various examples, a spell activation cost can be the number of influence cards (discussed further herein) required to activate the respective spell. A spell effect can have any desired effect on the game (e.g., the spell effect can indicate an action to take by one or more players and/or affecting an action, play, or turn). For example, a spell effect can have an effect on a player or team's cards and/or their characteristics, statistics, or statuses (whether in the player's hand, or active on the game surface), victory points collected by a player or team, a number of cards in a player's hand, and/or the like.

With additional reference to FIG. 9, spell card 900 is an example of spell cards included in card deck 310. Spell card 900 can comprise the spell title or name 910 and/or spell image 915 to identify the associated location. Spell card 900 can comprise spell species 912. Spell species 912 can match one of main character species 412, 414 (e.g., matching the sun/fire species in this example). Spell card 900 can comprise spell effect 940. As shown in FIG. 9, spell effect 940 allows the respective player to exhaust one of an opponent's active cards, such that the exhausted card cannot be used or take or cause any action during the opponent's next turn. Spell card 900 can comprise a spell activation cost 902 of 8.

The statistics, characteristics, or other information of a spell can be disposed in any suitable location on the spell card. As shown on spell card 900, the spell name/title can be disposed proximate and/or adjacent to a top edge of the respective spell card. The spell image or symbol 915 can be disposed approximately in the middle of a spell card (e.g., between the spell title/name and the spell effect). The spell effect 940 can be disposed proximate a bottom edge of the spell card (e.g., the component of a spell card most proximate a bottom edge of the spell card).

As used herein, “champion” can refer to the respective champion or champion card, “overlay” can refer to the respective overlay or overlay card, “location” can refer to the respective location or location card, and/or “spell” can refer to the respective spell or spell card.

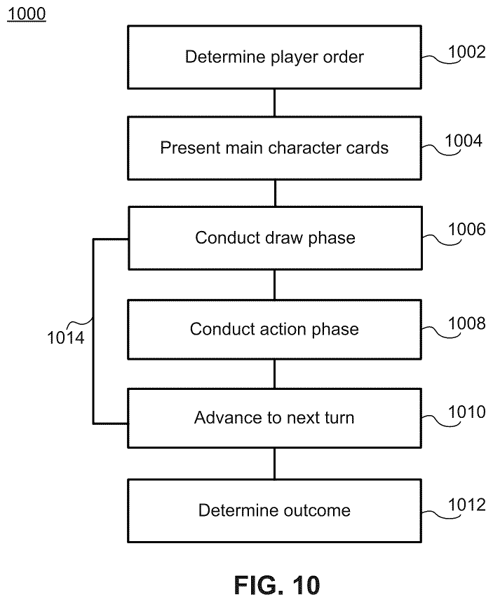

FIG. 10 illustrates a method 1000 for playing a game (e.g., using game system 100 and its components), in accordance with various examples. Game system 100 can be for two or more players, or two or more teams. For example, a game can involve a first player and a second player, wherein the second player is (and may be referred herein to as) the opponent to the first player. As another example, a game can involve a first team (including the first player) and a second team (including the second player, i.e., the opponent), wherein the second team is an opposing team to the first team. Each team playing a game as discussed herein can comprise an equal number of players.

A game utilizing game system 100 can comprise different stages. As used herein, a player's or team's “turn” refers to the respective player or team being able to take actions (e.g., activating or playing cards, causing champions or raid or attack, effectuating card effects, and/or the like). A player's or team's turn can comprise multiple “phases” during which the player or team can take certain actions or play certain cards. Once the phases of a player's or team's turn are complete, the game advances to allow the other player or team to have a similar turn. A “round” comprises a turn for the first player or team and a turn for the second player or team. A game can comprise one or more rounds, and the rounds or turns continue until a player or team wins the game. In various examples involving teams with multiple players each, the players on each team can all take actions, play cards, etc. during their respective turn at the same time (i.e., the players on a team may not have to wait for another player on their same team to take or complete an action to conduct their own actions).

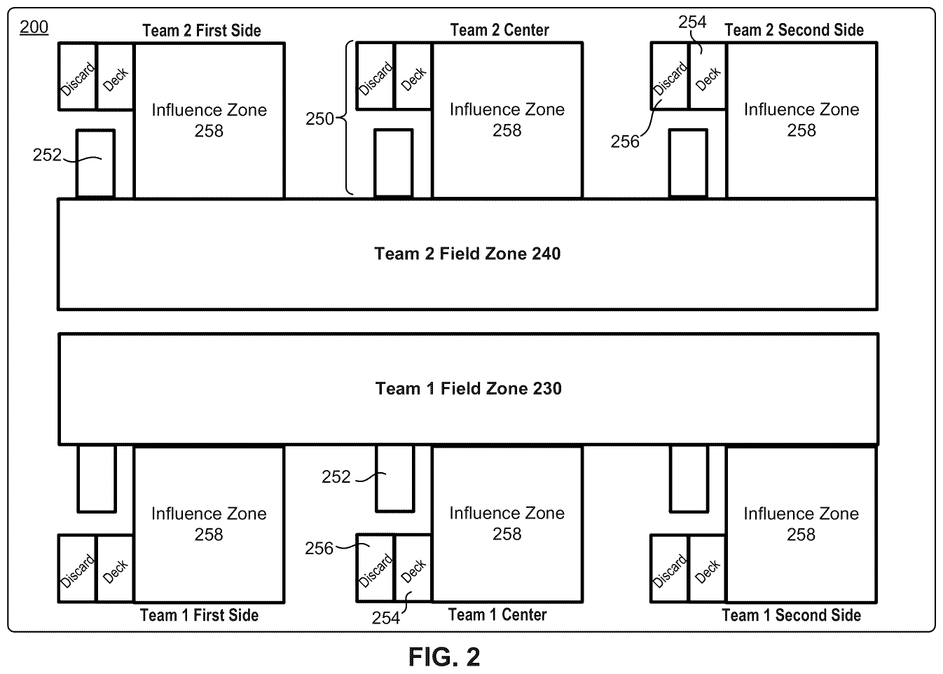

In various examples, to play the game of game system 100, each player can have a card deck (e.g., comprising about 40 action cards, a main character card, and/or one or more overlay cards). With additional reference to FIG. 2, game system 100 can be played on a game surface (e.g., game surface 200). A game surface for game system 100 can comprise any suitable arrangement of areas or components for players, cards, actions, and/or other aspects of the game. For example, each player utilizing game surface 200 can have their own space (e.g., player space 250). A player space can comprise a deck space 254 for the player's card deck, a discard space 256 to discard cards, a main character space 252 to dispose the player's main character card, and/or an influence zone 258, in which the player's influence cards can be disposed and added. As shown in FIG. 2, there are three players on each team, each having their own player space 250. Each player is positioned across or opposite from a player from the opposing team. In various examples, actions by each player will perform actions directed the player positioned across or opposite therefrom. Some actions (e.g., main character effects, champion effects, location effects, and/or spell effects) can be directed by a player at a teammate or at an opposing player that is not directly across from the respective player, as directed by the respective effect (e.g., an effect can instruct the player to choose any player at which to direct the effect).

Method 1000 will be discussed herein as if between a first player and second player (opponent) (e.g., a first team and a second, opposing, team each having one player), but it should be understood that the steps of the game and actions thereof can be taken by teams (e.g., the actions of a first player can be taken by multiple players of a first team (for example, simultaneously), and/or the actions of an opponent can be taken by multiple players of an opposing team (for example, simultaneously)).

In various examples, the first player and the opponent can determine a player order (step 1002) (i.e., who gets to go first). This can occur randomly by, for example, flipping a coin, rolling dice to see who gets the highest or lowest value, and/or the like. The first player and opponent can each present their respective main character card from each of their card decks (step 1004). The main character card for each player can be disposed faceup in the player's respective main character space 252 on game surface 200.

Each player can shuffle their respective action card deck (e.g., card deck 310 in FIG. 3) and place the action card deck facedown on game surface 200 (e.g., in deck space 254) so the action cards in the action card deck are unknown to the respective player. “Facedown,” as used herein, means the aspects or information on the respective card is hidden from a respective player. “Faceup,” as used herein, means the aspects or information on the respective card is revealed to a respective player. Each turn can comprise multiple phases. For example, a player's turn can comprise a draw phase and an action phase.

To begin the game, each player can draw a number of action cards from their respective card deck (e.g., about five, wherein in this context, “about” plus or minus two cards), which can be the player's hand or inventory. To begin a turn, the first player can conduct a draw phase (step 1006). During a draw phase, the first player can draw one or more action cards from the first player's card deck and add such action card(s) to the player's hand for use or play. In various examples, the first player draws one action card from the first player's card deck during the draw phase (e.g., draws one card from the top of the facedown action card deck). In various examples, a player may have an active action card or play an action card that can affect the draw phase of a turn. For example, the player can have a spell card, or an effect of an active champion card, location card, or the main character card that allows the player to draw two or more action cards during the draw phase of one or more of the player's turns. If a player cannot draw another card because their respective card deck has run out of cards, the other team can receive a victory point.

In various examples, a draw phase can include an influence phase, during which the respective player draws a card from the player's card deck and positions it facedown in the player's influence zone 258 on the game surface 200. Such cards may remain facedown (e.g., no players know what such cards are, including the respective player that drew the card). The facedown cards in the influence zone can be influence cards, which can be used to activate action cards (i.e., move a card from a player's hand onto the game surface for use during the game) and/or to play or effectuate a card effect. In response to an influence card being used to activate or play a card or effect, the influence card can be exhausted. In response to an influence card being exhausted, the respective card can be placed in a position or orientation, such as horizontally or at an angle (e.g., a nonparallel, nonorthogonal angle) relative to an edge of the game surface (e.g., the game surface edge proximate to the respective player), facedown, and/or the like, or an object can be associated with the card (e.g., a marble, token, or the like), to indicate exhaustion or an exhausted status.

In various examples, the first player can conduct an action phase (step 1008) of the first player's turn. The action phase can be in response to completion of the draw phase. During the action phase, the first player can activate and/or play one or more action cards. Playing a card can comprise effectuating the respective effect of a card (e.g., a main character effect, a champion effect, a location effect, and/or a spell effect), causing a champion card to raid or attack, and/or take any other action associated with an action card. In various examples, a card can be played after it has been activated from the player's hand onto the game surface. In various examples, an activated card can be played the same turn as activation. In various examples, an activated card may not be able to be played the same turn that the respective card is activated (e.g., an activated card can be played in a turn subsequent to the turn in which with the card is activated, such as the next turn).

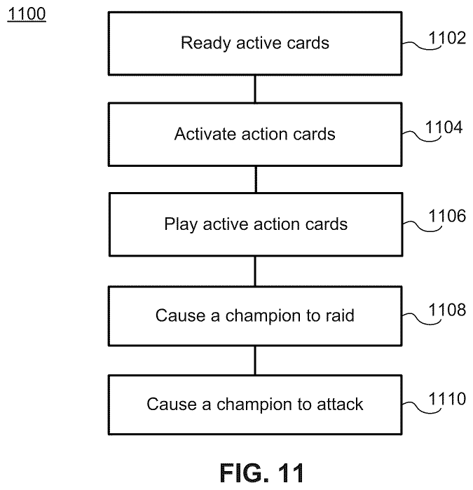

With additional reference to FIG. 11, a method 1100 for conducting an action phase during a game is depicted. Method 1100 will be described with regard to a first player conducting the action phase during the first player's turn, but the action phase can be conducted similarly by an opponent or any other player of the game during their respective turn(s). In various examples, an action phase can begin by the first player readying active cards (step 1102). A player's active cards can be those action cards activated from the player's hand and disposed faceup on the game surface, and active influence cards (that are facedown) drawn from the card deck during the draw or influence phase or as a result of some card effect (e.g., in the player's influence zone 258 and/or the team field zone 230). Readying an active card can comprise readying any exhausted active cards (i.e., un-exhausting active cards that were previously exhausted, e.g., in a past turn). That is, the first player may have used an active champion (e.g., used such champion to raid or attack) or a location effect of a location card in the previous turn, and thus, those cards may be in an exhausted status. Readying active cards can comprise disposing the readied cards from a position or orientation indicating an exhausted status (as discussed herein) to a position or orientation indicating a ready status, such as a vertical orientation relative to the respective player, faceup, and/or the like. Readying active action cards and influence cards can allow the first player to utilize or play such readied cards during the present turn. Thus, the readied influence cards can be available to activate cards from the player's hand onto the game surface, as discussed herein, and the readied action cards can be available for utilization and play. In various examples, the step of a game or turn in which a player readies active cards can occur at any suitable point, including before, during, and/or after the draw phase (e.g., at the very beginning of player's turn).

The action phase can comprise the first player activating action cards (step 1104), for example, a champion card(s), a location card(s), a spell card(s), and/or an overlay card(s). The first player can comprise the player's hand with action cards therein that are available to activate. The action cards in a player's hand may not be active (i.e., inactive), meaning that such action cards cannot be utilized to take an action or use a card effect associated with any of such action cards. To make the action cards in a player's hand available to utilize or play, the player can activate such action cards. To do so, the player can determine the number of influence cards in the player's influence zone 258. To activate an action card, the player can use a number of influence cards available to the player (e.g., in the player's influence zone 258) equal to the activation cost of the respective action card. For example, to activate champion card 500 from the respective player's hand to the game surface, the player may be required to use three influence cards. As another example, to activate location card 800 from the respective player's hand to the game surface, the player may be required to use five influence cards. Those influence cards used to activate an action card from the player's hand can be exhausted and disposed in a position or orientation to indicate an exhausted status. Thus, an influence card cannot be used in the same turn to activate two action cards (unless a played card effect allows the same, for example). During the player's subsequent turn, the exhausted influence cards from the previous turn can be readied (i.e., refreshed) for use during such subsequent turn (e.g., as discussed in relation to step 1102). As a game continues, each turn, a player receives additional influence cards, allowing activation of more action cards from the player's hand.

A player can activate as many action cards as desired and as allowed by the total number of influence cards available to the player. For example, if the player has five active influence cards and the player could activate champion cards 500 and 600 in the player's hand, the player could use (and exhaust) the five active influence cards to activate champion cards 500 and 600 (having champion activation costs of 3 and 2, respectively). As another example, a player can activate at least one champion card, at least one location card, and/or at least one spell card, wherein the total influence cards available to a player is greater than or equal to the sum of the activation cost of the activated champion card(s), the activation cost of the activated location card(s), and the activation cost of the activated spell card(s). In other words, the total number of influence cards for a player can or must cover the activation costs of any and all activated cards during a turn. In various examples, a player can only use the player's own influence cards to activate action cards. In various examples, a player can use the influence cards available on the player's team (e.g., influence cards for another player on the respective player's team).

The action phase can comprise the first player playing active action cards (step 1106). As discussed, active cards can be played to take action, which can include effectuating a respective card effect. Playing an action card can be in response to readying the active cards. Or, an active card may have already been in a ready status at the beginning of the first player's turn. As part of playing an action card, the first player can play an active champion, an active location, a spell, and/or the main character. In various examples, there can be an action limit, which is a maximum number of actions a card can take during a turn. For example, a card can only be used for one action per turn. Therefore, for cards having multiple options (e.g., a champion card being able to raid, attack, or use the champion effect), a player can decide which action to take during a turn.

In various examples, playing a champion card can comprise effectuating a champion effect (including an associated overlay card effect), and/or causing the champion to raid or attack. As discussed herein, a champion effect can have any desired effect, such as an effect on the respective player's active cards (e.g., allowing activation of an action card from the player's hand onto the game surface, e.g., for a decreased activation cost, moving an active action card back to the player's hand or discarding an active action card for a benefit such as receiving additional available influence cards, adding influence cards to the player's influence zone, and/or the like); an effect on an opponent's active cards (e.g., preventing activation of an action card from the opponent's hand onto the game surface, increasing the activation cost of activating an action card from the opponent's hand onto the game surface, de-activating an opponent's action card (e.g., by moving such action card from the game surface back into the opponent's hand), causing the opponent to discard an active action card or influence card or an action card in the opponent's hand, and/or the like); an effect on the status of the player's active cards (e.g., allowing an active card to be played on the same turn as activation of such card, exhausting an active action card for a benefit (e.g., increasing the statistics of another active action card), readying an exhausted action card before the player's subsequent turn, and/or the like); an effect on the status of the opponent's active cards (e.g., preventing playing or using an opponent's active action card, such as blocking a card effect, exhausting an opponent action card to prevent its use or play, readying an exhausted action card (e.g., to prevent collection of victory points), and/or the like); an effect on a statistic(s) or effect(s) of the player's active cards (e.g., increasing a statistic of an active action card); an effect on a statistic(s) of an opponent's active cards (e.g., decreasing a statistic(s) of the opponent's active cards); an effect on a player's main character (e.g., providing power to a main character, decreasing power of an opponent's main character, readying a main character effect that has previously been used or exhausted, exhausting an opponent's main character, and/or the like); an effect on a player's hand (e.g., causing a player to draw one or more action cards, causing an opponent to discard one or more action cards, and/or the like); and/or an effect on the number of victory points a player has collected (e.g., adding victory points for the respective player, and/or removing victory points from an opposing player).

A champion effect can be effectuated at any appropriate time, such as during the respective player's turn or during an opponent's turn (in response to a champion effect affecting the opponent's actions or plays). In various examples, a champion effect can be effectuated once per turn or round, or a champion effect can occur periodically (e.g., automatically every turn or round). To effectuate a champion effect, the respective player can announce the champion effect to the other player(s) and/or apply or implement the effect. In response to a champion effect being effectuated, the champion may be exhausted (so the champion can take no further action during the respective turn), and can be disposed in a position or orientation to indicate an exhausted status, as discussed herein. The exhausted champion can be readied during the player's next turn, as discussed in relation to step 1102.

In various examples, playing a champion card can comprise causing an active champion card to raid (step 1108) the opponent for victory points. Causing a champion to raid can comprise disposing the raiding champion in a position indicating the same (e.g., in field zone 230, and/or with a marble, token, or other raiding indicator). In response to a champion raiding, the raiding champion can be exhausted and can be disposed in a position or orientation to indicate an exhausted status. In response to a champion raiding, victory points can be associated with the raiding champion equal to the champion raid value of the raiding champion (taking into consideration any adjustments to the champion raid value from another card effect, e.g., a location effect, a spell effect, a main character effect, and/or a champion effect from another champion card). For example, in response to champion card 500 raiding during a player's turn, six victory points (which can be represented by marbles, tokens, chips, and/or any other suitable object) can be disposed on or proximate champion card 500, and champion card 500 can be moved into a position or orientation indicating an exhausted status.

In various examples, the player with the raiding champion may not receive the victory points associated with the raiding champion until the next turn when the raiding champion is readied. In response to a raiding champion being readied (e.g., in step 1102) in a subsequent turn, the respective player can receive the victory points from the raiding champion. In response to a raiding champion being readied before the player's subsequent turn (e.g., from a card effect or an opposing champion's attack, as discussed herein), the victory points from the raiding champion may be lost (i.e., the player may not collect such victory points). For example, during the opponent's turn after the present first player's turn, the opponent can play a spell card having a spell effect of readying a raiding champion on the other team. In response, because such raiding champion was readied before the first player's next turn, the victory points associated with the first player's raiding champion may be lost.

In various examples, playing a champion card can comprise causing an active champion card to attack (step 1110) a raiding opponent champion. The opposing team may have a raiding opponent champion (e.g., disposed in field zone 240) from the opposing team's preceding turn, having victory points associated with the raiding opponent champion. In response to the opposing team having a raiding opponent champion, the first player can cause one of the first player's active champions to attack the raiding opponent champion (e.g., by disposing the attacking champion card in field zone 230 aligned with the raiding opponent champion to which the attacking champion is directed). The attacking champion can be exhausted in response to attacking, and thus, can be disposed in a position or orientation indicating an exhausted status. In response, the raiding opponent champion can lose victory points equal to the raid value of the attacking champion, taking into consideration any modification to the respective raid values based on card effects, or the like. Thus, causing a champion card to attack an opponent's raiding champion can provide an opportunity to defend against the raiding champion to prevent the other player from receiving the full amount of victory points from the raid (if any at all).

In various examples, in response to a champion attacking a raiding opponent champion, the champion attack value of the attacking champion card can be compared to the champion attack value of raiding (defending) champion, taking into consideration any modification to the respective attack values based on card effects, or the like. The champion with the lower of the two champion attack values may be defeated and the champion card discarded. The victorious champion can remain. In response to a raiding champion being defeated that still has victory points associated therewith after comparing the raid values of the raiding and attacking champions, such victory points can be lost. In various examples, an attack value or raid value of the victorious champion can be reduced by the attack value or raid value, respectively, of the defeated champion. Thus, the victorious champion may be weaker if used to attack raiding opponent champions in subsequent turns. In response to the two champion attack values between an attacking champion and a raiding (defending) champion being equal, both champions can be defeated and the champion cards can be discarded.

In various examples, a player can take an action with each of the player active champions (e.g., raid, attack, and/or effectuate the champion effect). In various examples, in response to an attacking champion failing to block receipt of all victory points of a raiding champion of the other team, another champion can attack the raiding champion (in accordance with step 1110 and the discussion related thereto).

In various examples, playing a location card can comprise effectuating a location effect (including an associated overlay card effect). As discussed herein, a location effect can have any desired effect, such as an effect on the respective player's active cards (e.g., allowing activation of an action card from the player's hand onto the game surface, e.g., for a decreased activation cost, moving an active action card back to the player's hand or discarding an active action card for a benefit such as receiving additional available influence cards, adding influence cards to the player's influence zone, and/or the like); an effect on an opponent's active cards (e.g., preventing activation of an action card from the opponent's hand onto the game surface, increasing the activation cost of activating an action card from the opponent's hand onto the game surface, de-activating an opponent's action card (e.g., by moving such action card from the game surface back into the opponent's hand), causing the opponent to discard an active action card or influence card or an action card in the opponent's hand, and/or the like); an effect on the status of the player's active cards (e.g., allowing an active card to be played on the same turn as activation of such card, exhausting an active action card for a benefit (e.g., increasing the statistics of another active action card), readying an exhausted action card before the player's subsequent turn, and/or the like); an effect on the status of the opponent's active cards (e.g., preventing playing or using an opponent's active action card, such as blocking a card effect, exhausting an opponent action card to prevent its use or play, readying an exhausted action card (e.g., to prevent collection of victory points), and/or the like); an effect on a statistic(s) or effect(s) of the player's active cards (e.g., increasing a statistic of an active action card); an effect on a statistic(s) of an opponent's active cards (e.g., decreasing a statistic(s) of the opponent's active cards); an effect on a player's main character (e.g., providing power to a main character, decreasing power of an opponent's main character, readying a main character effect that has previously been used or exhausted, exhausting an opponent's main character, and/or the like); an effect on a player's hand (e.g., causing a player to draw one or more action cards, causing an opponent to discard one or more action cards, and/or the like); and/or an effect on the number of victory points a player has collected (e.g., adding victory points for the respective player, and/or removing victory points from an opposing player).

For example, location effect 840 of location card 800 can cause the respective player to claim one-half of victory points raided by a raiding champion before readying the respective champion. Therefore, in response to utilizing location effect 840, the player can claim one-half of the raided victory points without giving the opponent a chance to defend by attacking the raiding champion with an opponent champion (which may cause the player to lose at least some of the raided victory points) or prematurely readying the raiding champion causing victory point loss. In various examples, location cards may not take other actions such as raiding or attacking.

A location effect can be effectuated at any appropriate time, such as during the respective player's turn or during an opponent's turn (in response to a location effect affecting the opponent's actions or plays). In various examples, a location effect can be effectuated once per turn or round, or a location effect can occur periodically (e.g., automatically every turn or round). To effectuate a location effect, the respective player can announce the location effect to the other player(s) and/or apply or implement the effect. In response to a location effect being effectuated, the location may be exhausted (so the location can take no further action during the respective turn), and can be disposed in a position or orientation to indicate an exhausted status, as discussed herein. The exhausted location can be readied during the player's next turn, as discussed in relation to step 1102.

In various examples, a player can take an action with each of the player active locations (e.g., effectuating the location effect).

In various examples, playing an overlay card can comprise effectuating an overlay effect. An overlay card may have been previously activated and associated with another appropriate action card (e.g., a champion or location card with a matching card species). Overlay cards may not be activated unless an appropriate action card is active with which the overlay card can be associated and/or on which the overlay card will be disposed (e.g., overlay card 700 being associated with champion card 500 shown in FIG. 7B). As discussed herein, the overlay card can increase a statistic of the associated action card (e.g., increase a raid value or attack value of an associated champion card by covering and/or replacing such value on the champion card).

An overlay card can comprise an overlay effect that can be played. As discussed herein, an overlay effect can have any desired effect, such as an effect on the respective player's active cards (e.g., allowing activation of an action card from the player's hand onto the game surface, e.g., for a decreased activation cost, moving an active action card back to the player's hand or discarding an active action card for a benefit such as receiving additional available influence cards, adding influence cards to the player's influence zone, and/or the like); an effect on an opponent's active cards (e.g., preventing activation of an action card from the opponent's hand onto the game surface, increasing the activation cost of activating an action card from the opponent's hand onto the game surface, de-activating an opponent's action card (e.g., by moving such action card from the game surface back into the opponent's hand), causing the opponent to discard an active action card or influence card or an action card in the opponent's hand, and/or the like); an effect on the status of the player's active cards (e.g., allowing an active card to be played on the same turn as activation of such card, exhausting an active action card for a benefit (e.g., increasing the statistics of another active action card), readying an exhausted action card before the player's subsequent turn, and/or the like); an effect on the status of the opponent's active cards (e.g., preventing playing or using an opponent's active action card, such as blocking a card effect, exhausting an opponent action card to prevent its use or play, readying an exhausted action card (e.g., to prevent collection of victory points), and/or the like); an effect on a statistic(s) or effect(s) of the player's active cards (e.g., increasing a statistic of an active action card); an effect on a statistic(s) of an opponent's active cards (e.g., decreasing a statistic(s) of the opponent's active cards); an effect on a player's main character (e.g., providing power to a main character, decreasing power of an opponent's main character, readying a main character effect that has previously been used or exhausted, exhausting an opponent's main character, and/or the like); an effect on a player's hand (e.g., causing a player to draw one or more action cards, causing an opponent to discard one or more action cards, and/or the like); and/or an effect on the number of victory points a player has collected (e.g., adding victory points for the respective player, and/or removing victory points from an opposing player).

In various examples, in response to an overlay card being associated with an active champion or location card, the card combination with the overlay card and the champion or location card can have multiple effects. In various examples, only one of the effects can be effectuated during a turn. In various examples, one or more of the effects can be effectuated during a turn. In response to effectuating an overlay effect, the overlay card and the associated action card can be exhausted and disposed in a position or orientation indicating an exhausted status.

In various examples, active champion cards and/or location cards (including any associated overlay cards) can be played and/or their effects effectuated without a cost to do so (e.g., only the threshold activation cost to activate the respective action card from the player's hand onto the game surface). In such examples, every active action card can be utilized by a play, as desired, each turn. In various examples, in order to play an active champion card or location card (e.g., to raid, attack, or effectuate the effect thereof), the respective activation value of the action card can or must be satisfied with the player's influence cards. Thus, a player's influence cards can be divided between activating action cards and playing active action cards, and therefore can limit the activation of action cards and/or the playing of active action cards during a turn.

In various examples, a spell card can be played in the same way another action card is activated. For example, a spell can be activated from the player's hand at the time the player desires to effectuate the associated spell effect (e.g., by utilizing sufficient influence cards equal to the spell activation cost). In response to effectuating the spell effect, the spell card can be discarded. For example, as a defensive move, a player can play spell card 900 by exhausting eight influence cards, which allows the player to exhaust one of the opponent's active cards for the next turn (such that it cannot be played or used) via spell effect 940.

As discussed herein, a spell effect can have any desired effect, such as an effect on the respective player's active cards (e.g., allowing activation of an action card from the player's hand onto the game surface, e.g., for a decreased activation cost, moving an active action card back to the player's hand or discarding an active action card for a benefit such as receiving additional available influence cards, adding influence cards to the player's influence zone, and/or the like); an effect on an opponent's active cards (e.g., preventing activation of an action card from the opponent's hand onto the game surface, increasing the activation cost of activating an action card from the opponent's hand onto the game surface, de-activating an opponent's action card (e.g., by moving such action card from the game surface back into the opponent's hand), causing the opponent to discard an active action card or influence card or an action card in the opponent's hand, and/or the like); an effect on the status of the player's active cards (e.g., allowing an active card to be played on the same turn as activation of such card, exhausting an active action card for a benefit (e.g., increasing the statistics of another active action card), readying an exhausted action card before the player's subsequent turn, and/or the like); an effect on the status of the opponent's active cards (e.g., preventing playing or using an opponent's active action card, such as blocking a card effect, exhausting an opponent action card to prevent its use or play, readying an exhausted action card (e.g., to prevent collection of victory points), and/or the like); an effect on a statistic(s) or effect(s) of the player's active cards (e.g., increasing a statistic of an active action card); an effect on a statistic(s) of an opponent's active cards (e.g., decreasing a statistic(s) of the opponent's active cards); an effect on a player's main character (e.g., providing power to a main character, decreasing power of an opponent's main character, readying a main character effect that has previously been used or exhausted, exhausting an opponent's main character, and/or the like); an effect on a player's hand (e.g., causing a player to draw one or more action cards, causing an opponent to discard one or more action cards, and/or the like); and/or an effect on the number of victory points a player has collected (e.g., adding victory points for the respective player, and/or removing victory points from an opposing player).

A spell effect can be effectuated at any appropriate time, such as during the respective player's turn or during an opponent's turn (in response to a spell effect affecting the opponent's actions or plays). To effectuate a spell effect, the respective player can announce the spell effect to the other player(s) and/or apply or implement the effect.

As discussed herein, a main character effect can be played as part of the action phase. In response to the main character card having sufficient power associated therewith, as discussed herein, the player may effectuate the respective main character effect. As discussed herein, a main character effect can have any desired effect, such as an effect on the respective player's active cards (e.g., allowing activation of an action card from the player's hand onto the game surface, e.g., for a decreased activation cost, moving an active action card back to the player's hand or discarding an active action card for a benefit such as receiving additional available influence cards, adding influence cards to the player's influence zone, and/or the like); an effect on an opponent's active cards (e.g., preventing activation of an action card from the opponent's hand onto the game surface, increasing the activation cost of activating an action card from the opponent's hand onto the game surface, de-activating an opponent's action card (e.g., by moving such action card from the game surface back into the opponent's hand), causing the opponent to discard an active action card or influence card or an action card in the opponent's hand, and/or the like); an effect on the status of the player's active cards (e.g., allowing an active card to be played on the same turn as activation of such card, exhausting an active action card for a benefit (e.g., increasing the statistics of another active action card), readying an exhausted action card before the player's subsequent turn, and/or the like); an effect on the status of the opponent's active cards (e.g., preventing playing or using an opponent's active action card, such as blocking a card effect, exhausting an opponent action card to prevent its use or play, readying an exhausted action card (e.g., to prevent collection of victory points), and/or the like); an effect on a statistic(s) or effect(s) of the player's active cards (e.g., increasing a statistic of an active action card); an effect on a statistic(s) of an opponent's active cards (e.g., decreasing a statistic(s) of the opponent's active cards); an effect on a player's main character (e.g., providing power to a main character, decreasing power of an opponent's main character, readying a main character effect that has previously been used or exhausted, exhausting an opponent's main character, and/or the like); an effect on a player's hand (e.g., causing a player to draw one or more action cards, causing an opponent to discard one or more action cards, and/or the like); and/or an effect on the number of victory points a player has collected (e.g., adding victory points for the respective player, and/or removing victory points from an opposing player).

A main character effect can be effectuated at any appropriate time, such as during the respective player's turn or during an opponent's turn (in response to a main character effect affecting the opponent's actions or plays). In various examples, a main character effect can be effectuated once per turn or round, as allowed by the main character's power cost and power generation, or a main character effect can occur periodically (e.g., automatically every turn or round). To effectuate a main character effect, the respective player can announce the main character effect to the other player(s) and/or apply or implement the effect. In response to a main character effect being effectuated, the main character may be exhausted (so the main character can take no further action during the respective turn), and can be disposed in a position or orientation to indicate an exhausted status, as discussed herein.

In each action phase, each player can take as many actions as desired (e.g., using each active card for at least one action, or one action maximum per card, or as allowed by the number of influence cards required to take such actions).

In response to an action phase concluding, returning to method 1000 in FIG. 10, the game can advance to the next turn (step 1010). Thus, it becomes the other player or team's turn (i.e., the opponent). At the beginning of subsequent turns, an outcome can be determined (step 1012) based on the previous turns or rounds. For example, if it is now the opponent's turn, and in the previous opponent turn, the opponent had a raiding champion, the opponent can receive the victory points that remain associated with the raiding champion (after the first player had a chance to defend by attacking the raiding champion). Thus, upon receipt of such victory points, the victory point amount for each player or team can be determined (previously held victory points from previous turns plus newly received victory points).

In order to win the game, a player or team can accumulate a victory point amount that equals or exceeds a victory point threshold. A victory point threshold can be any suitable number (e.g., can be set by the players or game rules based on the desired duration of a game). In various examples, a victory point threshold can be dependent upon the number of players. The greater the number of players, the greater the victory point threshold can be. For example, with six players (three on each team), a victory point threshold can be greater than a victory point threshold for a game with four players (two on each team), which can be greater than a victory point threshold for a game with two players (one on each team).

In response to a player or team having a victory point amount that equals or exceeds a victory point threshold, that player or team can be determined the winner of the game. An outcome can be determined at any suitable point during a game, round, or turn, for example at any time during which a player or team receives victory points (e.g., in response to a card effect being effectuated, in response to a player having no more cards in their respective card deck, and/or the like). At the time that a player or team exceeds the victory point threshold, the player or team can be determined the winner of the game.

In response to both players or teams being below the victory point threshold, the game can continue by advancing to the next turn (step 1014). For a subsequent turn, method 1000 can return to step 1006, starting with the draw phase, readying cards that were exhausted from the previous turn or round, clearing the appropriate field zone on game surface 200, and/or proceeding with steps 1006-1010 as discussed herein. Turns can be conducted until a player or team meets or exceeds the victory point threshold.

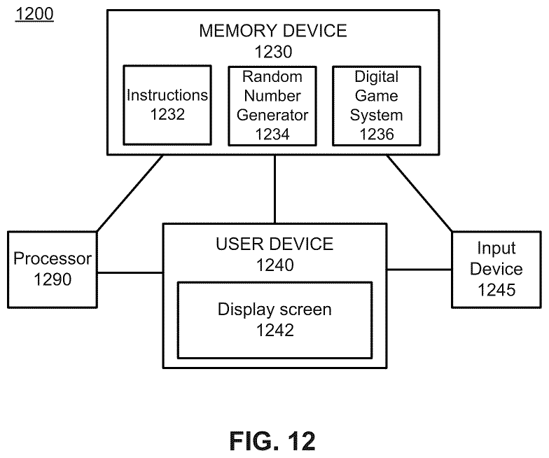

FIGS. 1-11 depict components and methods for a game system 100 implemented as a physical system. In various examples, the game of game system 100 can be implemented electronically and/or digitally. With reference to FIG. 12, in accordance with various examples, a system 1200 may be computer-based, and may comprise a processor 1290, a tangible non-transitory computer-readable memory device 1230, a user device 1240, and/or an input device 1245. In various examples, any or all of the components of system 1200 can be integrated, and/or in electronic communication, with one another via one or more application programming interfaces (APIs). System 1200 and/or any of the components comprised therein can be computer-based, and can comprise a processor (e.g., processor 1290), a tangible non-transitory computer-readable memory, and/or a network interface. Instructions stored on the tangible non-transitory memory (e.g., instructions 1232) can allow system 1200 or processor 1290, or the components therein, to perform various functions, as described herein. In various examples, each component of system 1200 can have a separate processor performing functions, or processor 1290 can be located in one or more components of system 1200, or processor 1290 can be a separate component of system 1200.

In various examples, memory device 1230 can comprise hardware and/or software capable of storing data and/or analyzing information. Memory device 1230 can comprise a server appliance running a suitable server operating system (e.g., MICROSOFT INTERNET INFORMATION SERVICES or, “IIS”) and having database software (e.g., ORACLE, mySQL) installed thereon. Memory device 1230 can be in electronic communication with a processor 1290, a user device 1240, and/or an input device 1245 via a network. As such, memory device 1230 can be able to communicate, and/or share information, with processor 1290, user device 1240, and/or input device 1245. Memory device 1230 can comprise a digital game system 1236 and its components, and/or instructions therefor (e.g., instructions 1232). Digital game system 1236 can be similar to game system 100 and its components and processes (as discussed herein in relation to FIGS. 1-11), such as a digital version thereof, including a digital game surface, an original digital deck of cards and digital cards therein (e.g., digital main character cards, and digital action cards including digital champion cards, digital location cards, digital spell cards, and/or digital overlay cards). Digital main characters cards can have the same or similar characteristics or functions within a game as the physical counterparts, e.g., main character card 400. The digital action cards (e.g., digital champion cards, digital location cards, digital spell cards, and/or digital overlay cards) of digital game system 1236 can have the same or similar characteristics, effects, structures, layouts, and/or functions within the digital game as the physical card counterparts (e.g., champion cards, location cards, spell cards, and/or overlay cards, respectively) within a physical game, as discussed herein. Additionally, the game rules, flow, actions, and the like associated with and discussed with regard to game system 100 and FIGS. 1-11 can also apply to digital game system 1236 and FIGS. 12-15.

Instructions 1232 can be configured to allow system 1200 to perform various operations to facilitate digital game system 1236 and its functions. Random number generator 1234 comprised in memory device 1230 can be utilized in operating digital game system 1236, as discussed herein. In various examples, instructions 1232, random number generator 1234, and/or digital game system 1236 can be comprised in one system, device, and/or component of system 1200 and/or memory device 1230, or the same can be separated or combined in any suitable configuration.

In various examples, memory device 1230 can store program code and or instructions 1232 executable by the processor 1290. Memory device 1230 can also store other data such as image data, event data, player input data, random or pseudo-random number generators, and applicable game rules that relate to the play of the digital game. Memory device 1230 can be a tangible non-transitory computer-readable memory. Random number generator 1234 can assist in randomizing the cards in a digital card deck and randomizing selection of digital cards therefrom. The random number generator 1234 can use various methodologies, for example, the random number generator techniques and systems set forth in U.S. Pat. No. 9,336,646 (which is hereby incorporated by reference), or any other random number generator techniques or systems now known or hereinafter devised.

In various examples, memory device 1230 can include random access memory (RAM), which can include non-volatile RAM (NVRAM), magnetic RAM (MRAM), ferroelectric RAM (FeRAM), and other forms as commonly understood in the gaming industry. In various examples, memory device 1230 can include read only memory (ROM). In various embodiments, memory device 1230 includes flash memory and/or EEPROM (electrically erasable programmable read only memory). It should be appreciated that, any other suitable magnetic, optical, and/or semiconductor memory can operate in conjunction with the system 1200.

Input device(s) 1045 can be an aspect of a graphical user interface (GUI) displayed on display screen which, in response to being selected, allows a user of system 1200 to produce an input signal received by a processor, which can command the processor to perform or facilitate performance of an operation. For example, input device 1245 can be a digital button displayed on a display screen (e.g., a touch screen) which can be selected by tapping the screen on a touch screen or selecting input device 1245 with a computer mouse, and/or input device 1245 can be a physical button to input information.

In various examples, memory device 1230 and/or user device 1240 can comprise a processor therein and/or utilize a processor in another component of system 1200 (e.g., processor 1290). The processor can be configured to cause the components of digital game system 1236 to interact with one another, to receive inputs from the user through an input device 1245, perform or execute the functions, or instruct/facilitate the performance of functions, including, for example, presenting information on a GUI to facilitate gameplay of a digital game system, randomly provide digital action cards to a player from the player's digital card deck as part of their digital hand, randomly draw influence cards from the digital card deck, play digital action cards in response to providing a computer player(s) for one-player game play, determine outcomes of different plays or actions (e.g., the effects of digital action cards that are played and/or active, the results of digital champion raids or attacks, and/or the like), turns (e.g., determining the order of players to conduct turns), determining scores (e.g., a number of victory points per player or team) at various points during a game, determining a game winner, and/or the like.

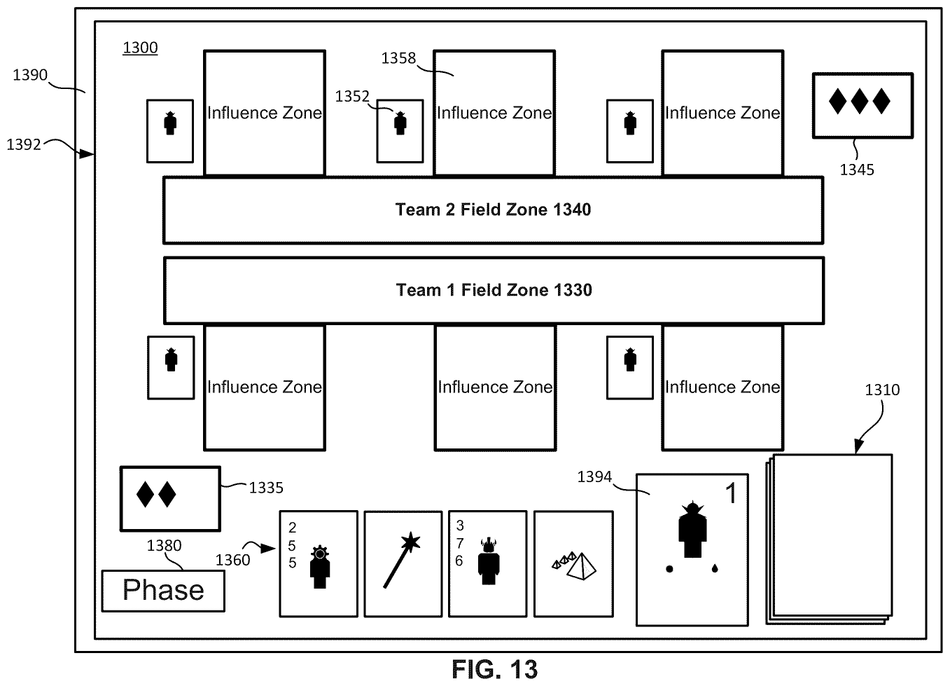

In various examples, user device 1240 can incorporate hardware and/or software components. For example, user device 1240 can comprise a server appliance running a suitable server operating system (e.g., MICROSOFT INTERNET INFORMATION SERVICES or, “IIS”). User device 1240 can be any device that allows a user to communicate with a network (e.g., a personal computer, personal digital assistant (e.g., IPHONE®, BLACKBERRY®), tablet, smartphone, cellular phone, and/or the like). User device 1240 can be in electronic communication with electronic memory device 1230, processor 1290, and/or input device 1245. In various examples, user device 1240 can comprise an input device 1245 (i.e., a physical or digital button). User device 1240 can allow the user of system 1200 to interact with the other components of system 1200. For example, user device 1240 can comprise display screen 1242, which can display a GUI (e.g., GUI 1300, discussed in relation to FIG. 13) provided by system 1200. Display screen 1242 displaying a GUI can allow the user to select input device(s) 1245 to send a signal to system 100 indicating a desired action by system 1200. In various examples, any action performed by a user through system 1200 can be communicated to system 1200 and performed by a processor (e.g., processor 1290).

User device 1240 includes any device (e.g., personal computer, mobile device, etc.) which communicates via any network, for example such as those discussed herein. In various examples, user device 1240 can comprise and/or run a browser, such as MICROSOFT® INTERNET EXPLORER®, MOZILLA® FIREFOX®, GOOGLE® CHROME®, APPLE® Safari, or any other of the myriad software packages available for browsing the internet. For example, the browser can communicate with a server via network by using Internet browsing software installed in the browser. The browser can comprise Internet browsing software installed within a computing unit or a system to conduct online transactions and/or communications. These computing units or systems can take the form of a computer or set of computers, although other types of computing units or systems can be used, including laptops, notebooks, tablets, handheld computers, personal digital assistants, set-top boxes, workstations, computer-servers, mainframe computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. In various examples, browser can be configured to display an electronic channel.

In various examples, a user device (e.g., as part of system 1200) described herein can run a web application or native application to communicate with system 1200. A native application can be installed on the user device via download, physical media, or an app store, for example. The native application can utilize the development code base provided for use with the operating system and capable of performing system calls to manipulate the stored and displayed data on the user device and communicates with system 1200 and/or any components thereof. A web application can be web-browser compatible and written specifically to run on a web browser. The web application can thus be a browser-based application that operates in conjunction with system 1200.

In various examples, memory device 1230 can comprise instructions 1232 to present a GUI to a player on a user device to allow digital game system 1236 to be played. With additional reference to FIG. 13, display screen 1392 of a user device 1390 (an example of display screen 1242 on user device 1240) can display components of digital game system 1236 on a game system GUI 1300 to facilitate playing of the digital game. The components of digital game system 1236 can be similar to the physical game discussed in relation to game system 100.

Similar to game system 100 discussed in relation to FIGS. 1-11, digital game system 1236 can comprise a digital deck of cards, which is an original deck of digital cards having various digital card types. The digital cards can be representations of digital items, which can be represented in any other suitable form (e.g., as digital tokens, items, figures, and/or any other suitable image or symbol). A digital card deck for digital game system 1236 can comprise digital cards, including digital main character cards and digital action cards (similar to card deck 310, including the number of digital cards therein). A digital deck of cards can be compiled by a player collecting physical cards having digital card counterparts, or digital-only cards, and create the digital card deck on the player's account or profile within digital game system 1236. Each player in a digital game can have their own digital card deck.

Similar to game play of game system 100, each player can have their own digital main character, and the processor can present each one on the GUI. As shown on GUI 1300 on FIG. 13, a digital main character 1352 is presented by the processor for each player, including the first player's main character 1394 (the first player may be operating user device 1390). The digital main character cards can have the same or similar displayed structure on GUI 1300 as the structure of the main character cards discussed in relation to game system 100 (e.g., main character card 400 in FIG. 4). For example, a digital main character card can comprise a main character name or title, power cost, card species, character image or symbol, and/or a main character effect. For reference, digital main character card 1394 is a digital version of main character card 400 in FIG. 4, and the aspects or statistics displayed on the digital cards correspond to the aspects or statistics displayed on the physical cards.

In various examples, GUI 1300 can be presented to a first player (e.g., the user of user device 1390). Thus, the opponent can be another user utilizing another device and providing inputs to system 1200 to play digital game system 1236, or the opponent can be a computer player operated by a processor, thus allowing one-player gameplay. GUI 1300 can display the digital card deck 1310, from which the respective player (e.g., the first player) can receive the digital action cards for the player's hand and digital influence cards for the respective influence zone 1358 on GUI 1300. Digital card deck 1310 can be displayed in GUI 1300 facedown so the players cannot see the next digital action card, or any digital cards, in digital card deck 1310. The first player's hand 1360 can be displayed on GUI 1300, which are the digital action cards available to activate by the first player during the first player's turn during a game. Any active digital action cards can be displayed faceup on GUI 1300 for the player to select to play (i.e., take action with) during a turn. The opponent's hand of digital action cards can be displayed on GUI 1300 facedown (i.e., hidden from the first player viewing GUI 1300), or not displayed at all, which can be the digital action cards available to activate by the opponent during the opponent's turn. The opponent's active digital action cards can be presented face up on GUI 1300 so all players can sec. The hand of digital action cards for each player can comprise any suitable number of cards to begin (e.g., about five digital action cards).

Similar to game system 100, digital game system 1236 can be played by any number of players. For example, digital game system 1236 can be configured for two teams having equal numbers of players. Each team can have one, two, or three players, or any suitable number of players. Each player can be disposed on GUI 1300 opposite to a player on the other team such that every player on one team is directly opposite of a player on the other team. In response to a player selecting an active digital action card to play during a turn, the processor can move or present such active digital action card in the respective field zone 1330 or 1340 proximate to the position of the respective player on GUI 1300. For example, in response to the first player having digital hand 1360 selecting an active digital champion to raid (as discussed herein), the processor can present the selected digital champion in front of the center influence zone (associated with the first player) to indicate that the selected digital champion is being played.

In various examples, GUI 1300 can display a phase indicator 1380, which can display the present phase of a team's turn. In various examples, GUI 1300 can display a victory point box, which can display the number of victory points a player or team as accumulated. For example, GUI 1300 shows that team 1 (including the first player) has two victory points in victory point box 1335 (represented by the two diamonds), and team 2 has three victory points in victory point box 1345 (represented by the three diamonds).

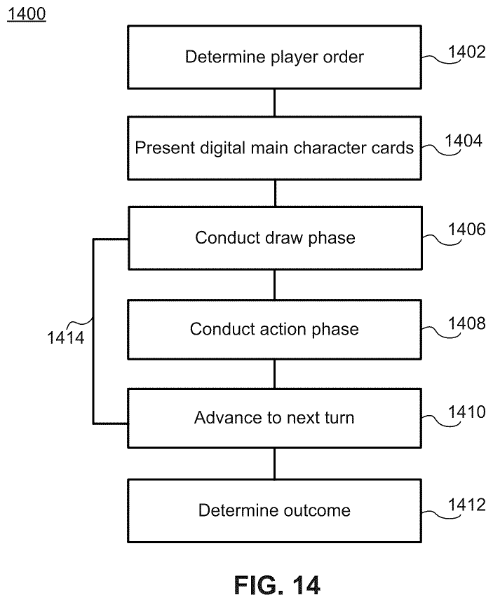

FIG. 14 illustrates a method 1400 for playing a digital game system 1236, for example, utilizing GUI 1300, in accordance with various examples. The functions and/or operations of digital game system 1236 can be performed by one or more processors, as discussed herein. In various examples, the processor can determine a player order (step 1402) for the game. For example, the processor can randomly determine the player order by rolling digital dice associated with each player or team and granting the first turn to the player or team with the highest digital dice roll, flipping a digital coin, and/or the like.

With reference to FIGS. 11-14, to begin a digital game, the processor can shuffle or randomize the digital card deck for each player and draw a number of digital action cards from each digital card deck for each player (e.g., about five, wherein in this context, “about” plus or minus two cards), which can be the player's digital hand or inventory. Such digital cards for the players' digital hands can be randomly selected by the processor from the player's respective digital card deck and/or can be the first five digital cards in the randomized (i.e., shuffled) digital card deck. The processor can present the digital main character card for each player (step 1404) on GUI 1300.

The digital game process will be discussed in relation to a first player and an opponent, but as discussed herein, the first player can be on a team having multiple players and the opponent can be on an opposing team having multiple players. Thus, the players on each team can each be taking the actions discussed herein during a turn (e.g., in sequence or at the same time).

In various examples, the processor can conduct a turn of the game. For example, it may be the first player's turn (which can be the first turn of the game or a turn subsequent to a previous opponent turn). To begin a turn, the processor can facilitate conducting a draw phase (step 1406). During a draw phase, the processor can draw one or more digital action cards from the first player's digital card deck and add such digital cards to the player's digital hand for future activation or play. In various examples, the first player draws one digital action card from the first player's digital card deck during the draw phase (e.g., draws one card from the top of the facedown digital action card deck). Any card effects that affect the draw phase of a game can be effectuated during the draw phase. For example, the processor can receive a selection of an active digital action card that has a card effect that affects the draw phase (e.g., allowing the player to draw two or more digital action cards during the draw phase of one or more of the player's turns). The processor can implement such card effect and draw digital action cards for the player's hand accordingly. In response to a respective digital card deck having no more digital cards for the player to draw, the processor can award the other team a victory point.

In various examples, a draw phase can include an influence phase, during which the processor can draw a digital card from the digital card deck and present it facedown in the respective player's influence zone 1358 on GUI 1300. Such digital cards can remain facedown on GUI (e.g., no players know what such digital cards are, including the respective player to which the digital influence card is associated). The facedown digital cards in the influence zone can be digital influence cards, which can be used to activate digital action cards (i.e., move a digital card from a player's digital hand onto the game surface on GUI 1300 for use during the digital game) and/or play or effectuate a card effect of an active digital action card. In response to a digital influence card being used to activate or play a digital card or card effect, the digital influence card can be exhausted. The processor can detect that an influence card was used, and in response, the processor can display the respective digital influence card in a position or orientation on GUI 1300, such as horizontally or at an angle (e.g., a nonparallel, nonorthogonal angle) relative to an edge of the GUI (e.g., the GUI edge proximate to the respective player or player digital hand), facedown, and/or the like, or an indicator can be associated with the card (e.g., a digital symbol, color change, or the like), to indicate exhaustion or an exhausted status.

In various examples, the processor can conduct an action phase (step 1408) of the first player's turn. The action phase can be in response to completion of the draw phase. The processor can detect conclusion of the draw phase and proceed to the action phase (e.g., updating phase indicator 1380 with the new phase). During the action phase, the first player can activate and/or play one or more digital action cards. Activating a digital card can comprise the player selecting a digital card to activate from the player's hand and moving the selected digital card from the player's digital hand onto the game surface on GUI 1300. Playing a digital card can comprise effectuating the respective effect of a digital card (e.g., a main character effect, a champion effect, a location effect, and/or a spell effect), causing a digital champion card to raid or attack, and/or the like. In various examples, a digital card can be played after it has been activated from the player's digital hand onto the game surface. In various examples, a digital activated card can be played the same turn as activation. In various examples, an activated digital card may not be able to be played the same turn that the respective digital card is activated (e.g., an activated digital card can be played in a turn subsequent to the turn in which with the digital card is activated, such as the next turn).

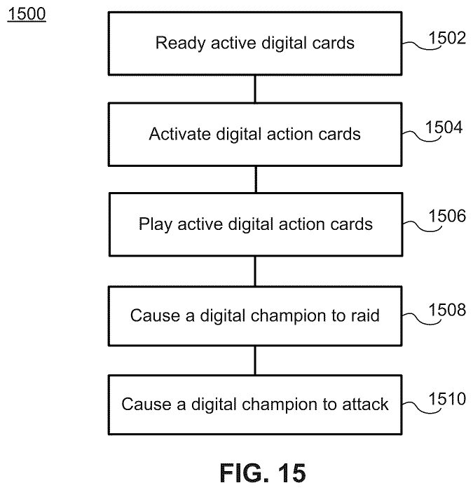

With additional reference to FIG. 15, a method 1500 for conducting an action phase during a digital game is depicted. In various examples, an action phase can begin by the processor readying active digital cards (step 1502). A player's active digital cards can be those activated from the player's digital hand and disposed faceup on the game surface on GUI 1300, and active digital influence cards (that are facedown) (e.g., in the player's respective influence zone 1358 and/or the team field zone 1330). Readying an active digital card can comprise the processor detecting which active digital cards are in an exhausted state (e.g., as indicated by the position or orientation of the digital card on GUI 1300, by a marker, symbol, color change, and/or any other suitable indicator of an exhausted status). In response, the processor can ready the exhausted active digital cards (i.e., un-exhausting active digital cards that were previously exhausted, e.g., in a past turn), for example by moving or redisposing active digital cards in a position, orientation, or configuration (e.g., with symbols, colors, etc.) that indicate the active digital cards are in a ready status. The first player can select the readied digital cards for utilization or play to take action or effectuate a respective card effect. Thus, the readied digital influence cards can be available to activate digital cards from the player's digital hand onto the game surface on GUI 130, as discussed herein, and the readied digital action cards can be available for utilization and play. In various examples, the step of a digital game in which the active digital cards are readied can occur at any suitable point, including before, during, and/or after the draw phase (e.g., at the very beginning of player's turn).

The action phase can comprise the processor activating digital action cards (step 1504), for example, a digital champion card(s), a digital location card(s), a digital spell card(s), and/or a digital overlay card(s) from the player's digital hand. The first player's digital hand 1360 can comprise digital action cards therein that are available to activate. The digital action cards in a player's digital hand may not be active (i.e., inactive), meaning that such digital action cards cannot be utilized to take an action or use a card effect associated with any of such digital action cards. To make the digital action cards in a player's digital hand available to utilize or play, the player can select digital action cards to activate. The processor can receive such selections of the digital cards in the player's digital hand. To activate such digital cards, the processor can determine the number of digital influence cards in the player's influence zone respective 1358. To activate a digital action card, the player can have a number of digital influence cards equal to the activation cost of the respective digital card that is to be activated. The processor can compare the number of the player's digital influence cards and the activation cost of the selected digital action card to activate. In response to the number of available digital influence cards being greater than or equal to the activation cost of the selected digital action card, the processor can activate the selected digital action card by removing the selected digital action card from the player's digital hand and presenting it as an active digital action card on GUI 1300.

For example, to activate a digital champion card similar to champion card 600 from the respective player's digital hand to the game surface on GUI 1300, the processor can detect the activation cost of the digital champion card to be 2. The processor can determine that two digital influence cards are required to activate the selected digital champion card. The processor can compare the activation cost to the available digital influence cards associated with the player. In response to the number of active digital influence cards being greater than or equal to the activation cost, the processor can activate the selected digital champion card. The processor can exhaust the digital influence cards used to activate a digital action card from the player's digital hand by disposing or presenting the used digital influence cards in a manner that indicates an exhausted status, as discussed herein. Thus, a digital influence card cannot be used in the same turn to activate two digital action cards (unless a played digital card effect allows the same, for example). During the player's subsequent turn, the processor can ready the exhausted digital influence cards from the previous turn for use during such subsequent turn (e.g., as discussed herein in relation to step 1502).

A player can activate as many digital action cards as desired and as allowed by the total number of digital influence cards available to the player. For example, a player can activate at least one digital champion card, at least one digital location card, and/or at least one digital spell card, wherein the processor determines that the total digital influence cards available to a player is greater than or equal to the sum of the activation cost of the activated digital champion card(s), the activation cost of the activated digital location card(s), and/or the activation cost of the activated digital spell card(s). In other words, the processor can determine whether total number of digital influence cards for a player can cover the activation costs of any and all digital cards that a player desires to activate during a turn. In various examples, the processor can detect digital influence cards of the player's teammates, and can utilize those digital influence cards to activate digital cards from the player's digital hand.

The action phase can comprise the first player playing digital action cards (step 1506). As discussed, active digital cards can be played to take action, including effectuating a respective card effect. Playing a digital action card can be in response to readying the active digital cards. Or, an active digital card may have already been in a ready status at the beginning of the first player's turn. As part of playing a digital action card, the first player can select an active digital action card to play, and the processor can receive such a selection. For example, the player can select an active digital champion, an active digital location, a digital spell, and/or the digital main character to play. In various examples, there can be an action limit, which is a maximum number of actions a digital card can take during a turn. For example, a digital card can only be used for one action per turn (e.g., deciding between having a digital champion raid, attack, or use the champion effect). The processor can detect whether an active digital card has been used or played and reached the action limit, and if so, can prohibit such active digital card from taking further action during the same turn.

In various examples, the first player can select a digital champion card to play. The player can select the action or play of the digital champion card to be the effectuation of a champion effect (including an associated overlay card effect), and/or causing the champion to raid or attack. In response to receiving a selection to effectuate the champion effect of a digital champion, the processor can detect the champion effect associated with the digital champion and effectuate the same. A champion effect of a digital champion card can have any desired effect, such as those discussed with regard to the champion cards of game system 100 herein.

The processor can effectuate a champion effect at any appropriate time, such as during the respective player's turn or during an opponent's turn (in response to a champion effect affecting the opponent's actions or plays). In various examples, the processor can effectuate a champion effect once per turn or round, or the processor can effectuate a champion effect periodically (e.g., automatically every turn or round). In response to a champion effect being effectuated, the champion may be exhausted (so the champion can take no further action during the respective turn). Accordingly, the processor can display the respective digital champion card in a manner to indicate an exhausted status, as discussed herein. The processor can ready the exhausted digital champion during the player's next turn, as discussed in relation to step 1502.

In response to receiving a selection to cause an active digital champion card to raid, the processor can cause the selected active digital champion card to raid (step 1508) the opponent for victory points. Causing a digital champion to raid can comprise the processor moving the selected active digital champion into a position indicating that the digital champion is raiding (e.g., moving the selected active digital champion to the respective field zone 1330 on GUI 1300). In response to a digital champion raiding, the processor can determine the raid value of the raiding digital champion, and adjust the same in accordance with any adjustments from another card effect, e.g., a location effect, a spell effect, a main character effect, and/or a champion effect from another digital champion card). In response to determining the raid value of the raiding digital champion, the processor can associate a number of victory points with the raiding digital champion equal to the associated raid value. The victory points can be digital tokens, gems, shapes or the like disposed on or proximate the raiding digital champion on GUI 1300. In response to causing the selected digital champion to raid, the digital champion can be exhausted and can be presented on GUI 1300 in a manner to indicate an exhausted status, as discussed herein. For example, in response to a digital champion card resembling champion card 600 raiding during a player's turn, the processor can associate five victory points with the digital champion card and present the digital champion card in a manner on GUI 1300 indicating an exhausted status.

In various examples, the victory points associated with the raiding digital champion can remain with the raiding digital champion (and not associated with the player as part of the player's total victory points) until the player's next turn. In response to a raiding champion being readied (e.g., in step 1502) in a subsequent turn, the processor can associate the victory points remaining on the readied digital champion (that was raiding last turn) with the respective player or team. Such victory points associated and received by the player can be reflected in the player's victory point box 1335. In response to a raiding digital champion being readied before the player's subsequent turn (e.g., from a card effect or an opposing digital champion's attack, as discussed herein), the processor can disassociate an appropriate number of victory points from the raiding digital champion, such that the player will not receive such disassociated victory points.

In response to receiving a selection to cause an active digital champion card to attack, the processor can cause the selected active digital champion card to attack (step 1510) a raiding opponent champion. The opponent may have selected in the opponent's previous turn to have an active opponent digital champion raid the first player for victory points. The raiding opponent digital champion may be disposed in the respective field zone 1340 on GUI 1300 and have victory points associated therewith (equal to the raid value of the raiding opponent digital champion). The processor can cause the first player's selected digital champion to attack the raiding opponent digital champion. In response, the processor can dispose the attacking digital champion card in the respective field zone 1330 aligned with the raiding opponent digital champion to which the attacking digital champion is directed. In response, the attacking digital champion can be exhausted in response to attacking, and thus, the processor can present the attacking digital champion in manner indicating an exhausted status. The processor can determine the raid value of the attacking digital champion, taking into consideration any modification to the respective raid value based on card effects, or the like, and subtract a number of the victory points associated with the raiding opponent digital champion equal to the determined raid value of the attacking digital champion. Thus, causing a digital champion card to attack an opponent's raiding digital champion can provide an opportunity to defend against a raiding digital champion to prevent the other player from receiving the full amount of victory points from the raid (if any at all).

In various examples, in response to a digital champion attacking a raiding opponent digital champion, the processor can compare the champion attack value of the attacking digital champion card to that of the raiding (defending) opponent digital champion, taking into consideration any modifications to the respective attack values based on card effects, or the like. The processor can determine which digital champion has the lower of the two champion attack values, and can determine that such digital champion is defeated. In response, the processor can discard such digital champion card. The victorious digital champion can remain. In various examples, the processor can reduce the attack value or raid value of the victorious digital champion by the attack value or raid value, respectively, of the defeated digital champion. Thus, the victorious digital champion may be weaker if used to attack raiding opponent digital champions in subsequent turns. In response to the two champion attack values between an attacking digital champion and a raiding (defending) opponent digital champion being equal, both digital champions can be defeated and the digital champion cards can be discarded.

In various examples, a player can take an action with each of the player active digital champions (e.g., raid, attack, and/or effectuate the champion effect). In various examples, in response to an attacking digital champion failing to block receipt of all victory points of a raiding digital champion of the other team, a player can select another digital champion to attack the raiding digital champion (in accordance with step 1110 and the discussion related thereto).

In various examples, the first player can select a digital location card to play. The player can select the action or play of the digital location card to be effectuating a location effect (including an associated overlay card effect). In response to receiving a selection to effectuate the location effect of a digital location, the processor can detect the location effect associated with the digital location and effectuate the same. A location effect of a digital location card can have any desired effect, such as those discussed with regard to the location cards of game system 100 herein.

The processor can effectuate a location effect at any appropriate time, such as during the respective player's turn or during an opponent's turn (in response to a location effect affecting the opponent's actions or plays). In various examples, the processor can effectuate a location effect once per turn or round, or the processor can effectuate a location effect periodically (e.g., automatically every turn or round). In response to a location effect being effectuated, the digital location may be exhausted (so the digital location can take no further action during the respective turn). Accordingly, the processor can display the respective digital location card in a manner to indicate an exhausted status, as discussed herein. The processor can ready the exhausted digital location during the player's next turn, as discussed in relation to step 1502.

In various examples, a player can select a digital overlay card from the player's digital hand to activate. In response, the processor can verify that the player has sufficient digital influence cards available for such activation by comparing the overlay activation cost with the available digital influence cards. The player can select the active action card with which the digital overlay card will be activated. The processor can receive such a selection and compare the overlay value of the digital overlay card with the overlay allowance of the selected action card (e.g., a digital champion card). In response to the overlay value of the digital overlay card being less than or equal to the overlay allowance of the selected action card, the processor can associate the digital overlay card with the selected action card (e.g., by disposing the digital overlay card over the selected action card).

In various examples, the first player can select the action or play of the digital overlay card to be effectuating an overlay effect. In response to receiving a selection to effectuate the overlay effect of a digital overlay, the processor can detect the overlay effect associated with the digital overlay and effectuate the same. An overlay effect of a digital overlay card can have any desired effect, such as those discussed with regard to the overlay cards of game system 100 herein.

In various examples, active digital champion cards and/or digital location cards (including any associated overlay cards) can be played and/or their effects effectuated without a cost to do so (e.g., only the threshold activation cost to activate the respective digital action card from the player's digital hand onto the digital game surface). In various examples, in order to play an active digital champion card or digital location card (e.g., to raid, attack, or effectuate the effect thereof), the respective activation value of the digital action card can be satisfied with the player's digital influence cards, and the processor can determine the same. Thus, in various examples, a player's digital influence cards can be divided between activating digital action cards and playing active digital action cards.

In various examples, a digital spell card can be played in the same way another digital action card is activated. For example, the processor can activate a digital spell from the player's digital hand at the time the player desires to effectuate the associated spell effect (e.g., by utilizing sufficient digital influence cards equal to the spell activation cost). In response to effectuating the spell effect, the processor can discard digital spell card. A spell effect of a digital spell card can have any desired effect, such as those discussed with regard to the spell cards of game system 100 herein. The processor can effectuate a spell effect at any appropriate time, such as during the respective player's turn or during an opponent's turn (in response to a spell effect affecting the opponent's actions or plays).

As discussed herein, a main character effect of a digital main character card can be played as part of the action phase. The processor can determine a power level of the digital main character card. In response to the processor determining that the digital main character card has sufficient power associated therewith (e.g., greater than or equal to the power cost of the digital main character), as discussed herein, the processor can effectuate the respective digital main character effect in response to the player making such a selection. A main character effect of a digital main character card can have any desired effect, such as those discussed with regard to the main character cards of game system 100 herein. The processor can effectuate a main character effect at any appropriate time, such as during the respective player's turn or during an opponent's turn (in response to a main character effect affecting the opponent's actions or plays). In various examples, a main character effect can be effectuated once per turn or round, as allowed by the digital main character's power cost and power generation, or a main character effect can occur periodically (e.g., automatically every turn or round).

In each action phase, each player can take as many actions as desired (e.g., using each active digital action card for at least one action, or one action maximum, or as allowed by the number of influence cards required to take such actions).

In response to an action phase concluding, returning to method 1400 in FIG. 14, the processor can advance the digital game to the next turn (step 1410). Thus, it becomes the opponent's turn. At the beginning of subsequent turns, the processor can determine an outcome (step 1412) based on the previous turns or rounds. For example, if it is now the opponent's turn, and in the previous opponent turn, the opponent had a raiding digital champion (e.g., the raiding opponent digital champion that the first player's attacking digital champion attacked), the processor can associate the victory points that remain associated with the raiding opponent digital champion with the opponent (after the first player had a chance to defend by attacking the raiding champion). The processor can reflect such received victory points in the opponent's victory point box 1345. Thus, upon receipt of such victory points, the processor can determine the victory point amount for each player (e.g., by adding previously held victory points from previous turns plus newly received victory points).

In order to win the game, a player or team can accumulate a victory point amount that equals or exceeds a victory point threshold. The processor can compare the victory point amounts of each player with the victory point threshold. In response to a player or team having a victory point amount that equals or exceeds a victory point threshold, the processor can determine that that player or team is the winner of the game. The processor can determine an outcome (e.g., a winner) at any suitable point during a game, round, or turn, for example at any time during which a player or team receives victory points (e.g., in response to a card effect being effectuated, in response to a player having no more digital cards in their respective digital card deck, and/or the like). At the time that a player or team exceeds the victory point threshold, the processor can determine that player or team the winner of the game.

In response to both players or teams being below the victory point threshold, the processor can continue the game by advancing to the next turn (step 1414) (which may be the opponent's turn). For a subsequent turn, method 1400 can return to step 1406, starting with the draw phase, the processor readying opponent's active digital cards that were exhausted from the previous turn or round (including the raiding opponent digital champion that may yield victory points, as discussed herein), clearing the appropriate field zone on GUI 1300, and/or proceeding with steps 1406-1410 as discussed herein. Turns can be conducted until a player or team meets or exceeds the victory point threshold.

The game and game components disclosed herein, in both physical and electronic versions, may incorporate reasonable design parameters, features, modifications, advantages, and variations that are readily apparent to those skilled in the art in the field of the game design and/or the game industry.

Although a number of different examples and embodiments of the game systems described herein and corresponding methods of playing the game systems have been illustrated and described herein, one or more features of any one embodiment can be combined with one or more features of one or more of the other embodiments.

While a number of exemplary aspects and embodiments of the game system and corresponding method of play have been discussed above, those of skill in the art will recognize certain modifications, permutations, additions and sub-combinations thereof. It is therefore intended that the following appended claims and claims hereafter introduced are interpreted to include all such modifications, permutations, additions, and sub-combinations as are within their true spirit and scope.

Systems, methods and computer program products are provided. In the detailed description herein, references to “various examples”, “one example”, “an example”, etc., indicate that the example described can include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described. After reading the description, it will be apparent to one skilled in the relevant art(s) how to implement the disclosure in alternative examples.

As used herein, “satisfy”, “meet”, “match”, “associated with” or similar phrases can include an identical match, a partial match, meeting certain criteria, matching a subset of data, a correlation, satisfying certain criteria, a correspondence, an association, an algorithmic relationship and/or the like.

Terms and phrases similar to “associate” and/or “associating” can include tagging, flagging, correlating, using a look-up table or any other method or system for indicating or creating a relationship between elements, such as, for example, (i) an action card (e.g., champion card), (ii), an action card effect (e.g., champion effect), and/or (iii) a player or player hand. Moreover, the associating can occur at any point, in response to any suitable action, event, or period of time. The associating can occur at pre-determined intervals, periodic, randomly, once, more than once, or in response to a suitable request or action. Any of the information can be distributed and/or accessed via a software enabled link, wherein the link can be sent via an email, text, post, social network input and/or any other method known in the art.

Unless specifically stated otherwise, as apparent from the discussion herein, it is appreciated that throughout this specification, discussions utilizing terms such as “processing,” “computing,” “calculating,” “determining” or the like refer to actions or processes of a processor, such as a processor on a special purpose computer or a similar special purpose electronic computing device. In the context of this description, therefore, a special purpose computer or a similar special purpose electronic computing device is capable of manipulating or transforming signals, typically represented as physical electronic or magnetic quantities within memories, registers, or other information storage devices, transmission devices, or display screens of the special purpose computer or similar special purpose electronic computing device.

The system and method can be described herein in terms of functional block components, screen shots, optional selections and various processing steps. It should be appreciated that such functional blocks can be realized by any number of hardware and/or software components configured to perform the specified functions. For example, the system can employ various integrated circuit components, e.g., memory elements, processing elements, logic elements, look-up tables, and the like, which can carry out a variety of functions under the control of one or more microprocessors or other control devices. Similarly, the software elements of the system can be implemented with any programming or scripting language such as C, C++, C #, JAVA®, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system can employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module can take the form of a processing apparatus executing code, an internet-based example, an entirely hardware example, or an example combining aspects of the internet, software and hardware. Furthermore, the system can take the form of a computer program product on a computer-readable storage medium having computer-readable program code means embodied in the storage medium. Any suitable computer-readable storage medium can be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various examples. It will be understood that each functional block of the block diagrams and the flowchart illustrations, and combinations of functional blocks in the block diagrams and flowchart illustrations, respectively, can be implemented by computer program instructions.

These computer program instructions can be loaded onto a general-purpose computer, special purpose computer, or other programmable data processing apparatus to produce a machine, such that the instructions that execute on the computer or other programmable data processing apparatus create means for implementing the functions specified in the flowchart block or blocks. These computer program instructions can also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions can also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein can comprise in any number of configurations including the use of WINDOWS®, webpages, web forms, popup WINDOWS®, prompts and the like. It should be further appreciated that the multiple steps as illustrated and described can be combined into single webpages and/or WINDOWS® but have been expanded for the sake of simplicity. In other cases, steps illustrated and described as single process steps can be separated into multiple webpages and/or WINDOWS® but have been combined for simplicity.

For clarity in discussing the various functions of the system, multiple computers and/or servers are discussed as performing different functions. These different computers (or servers) can, however, be implemented in multiple different ways such as modules within a single computer, as nodes of a computer system, etc. The functions performed by the system (or nodes or modules) can be centralized or distributed in any suitable manner across the system and its components, regardless of the location of specific hardware. Furthermore, specific components of the system can be referenced using functional terminology in their names. The function terminology is used solely for purposes of naming convention and to distinguish one element from another in the following discussion. Unless otherwise specified, the name of an element conveys no specific functionality to the element or component. It should be appreciated that, in various examples, the software, hardware, and associated components of the system can be programmed and configured to implement one or more examples described herein. It should also be appreciated that the various aspects of the system can be exemplified as software, modules, nodes, etc., of a computer or server.

As used herein, “transmit,” “transfer,” and/or the like can include sending electronic data from one system component to another over a network connection. Additionally, as used herein, “data” can include encompassing information such as commands, queries, files, data for storage, and the like in digital or any other form.

As used herein, the term “network” includes any cloud, cloud computing system or electronic communications system or method which incorporates hardware and/or software components. Communication among the parties can be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system can also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA® 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific examples. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone can be present in an example, B alone can be present in an example, C alone can be present in an example, or that any combination of the elements A, B and C can be present in a single example; for example, A and B, A and C, B and C, or A and B and C. Although the disclosure includes a method, it is contemplated that it can be embodied as computer program instructions on a tangible computer-readable carrier, such as a magnetic or optical memory or a magnetic or optical disk. All structural, chemical, and functional equivalents to the elements of the above-described various examples that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

No claim element is intended to invoke 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but can include other elements not expressly listed or inherent to such process, method, article, or apparatus.

What is claimed is:

1. A method of playing a game on a game surface, comprising:
conducting, by a first team, a first player turn of the game, comprising:
drawing, by a first player on the first team, a card from a player card deck into a player hand of cards for the first player, wherein the player card deck is disposed facedown on the game surface, wherein the player card deck comprises 20 to 60 cards including at least one champion card, at least one location card, and at least one spell card, wherein the player card deck further comprises at least one overlay card, wherein the overlay card is at least partially transparent and is configured to be disposed over at least a portion of the at least one champion card, wherein the overlay card comprises at least one component that aligns with at least one component of the at least one champion card in response to being disposed over the at least one champion card,
wherein each champion card of the at least one champion card has champion statistics associated therewith comprising a champion activation cost, a champion attack value, and a champion raid value,
wherein each location card of the at least one location card comprises a location activation cost and a location effect, wherein the location effect affects at least one of a status of an active champion card of the first player or an opponent on an opposing team, a champion statistic of an active champion card of the first player or the opponent, victory points collected by the first player or the opponent, or a number of cards in the player hand or an opponent hand of the opponent, and
wherein each spell card of the at least one spell card comprises a spell activation cost and a spell effect, wherein the spell effect affects at least one of the status of an active champion card of the first player or the opponent, a champion statistic of an active champion card of the first player or the opponent, victory points collected by the first player or the opponent, or a number of cards in the player hand or the opponent hand of the opponent;
adding, by the first player, an additional player influence card to a player influence zone of the game surface, wherein the adding the additional player influence card comprises drawing, by the first player, the additional player influence card from the player card deck and disposing the additional player influence card facedown in the player influence zone;
determining a total number of player influence cards in the player influence zone; and
conducting a player action phase, comprising:
activating, by the first player, at least one card from the player hand by disposing the at least one card from the player hand onto the game surface, comprising at least one of:
activating a player champion card, wherein the player champion card comprises a player champion activation cost indicating a required number of influence cards to activate the player champion card;
activating a player location card, wherein the player location card comprises a player location activation cost indicating a required number of influence cards to activate the player location card; or
activating a player spell card, wherein the player spell card comprises a player spell activation cost indicating a required number of influence cards to activate the player spell card,
wherein a total of at least one of the player champion activation cost, the player location activation cost, and the player spell activation cost is equal to or less than the total number of player influence cards in the player influence zone;
playing, by the first player, an active player card that was activated in a previous turn, wherein the active card comprises an active player champion, wherein the playing the active player champion comprises causing the active player champion to raid the opponent;
disposing a number of victory points on the raiding active player champion equal to the champion raid value for the raiding active player champion; and
disposing the raiding active player champion in an exhausted position to indicate an exhausted status;
conducting, by the opposing team, a first opponent turn of the game, comprising:
drawing, by the opponent, a card from an opponent card deck into the opponent hand, wherein the opponent card deck is disposed facedown on the game surface, wherein the opponent card deck comprises 20 to 60 cards including at least one champion card, at least one location card, and at least one spell card, wherein the opponent card deck further comprises at least one overlay card, wherein the at least one overlay card is at least partially transparent and is configured to be disposed over at least a portion of the at least one champion card, wherein the at least one overlay card comprises at least one component that aligns with at least one component of the at least one champion card in response to being disposed over the at least one champion card,
adding, by the opponent, an opponent influence card to an opponent influence zone of the game surface, wherein the adding the opponent influence card comprises drawing, by the opponent, the opponent influence card from the opponent card deck and disposing the opponent influence card facedown in the opponent influence zone;
determining a total number of opponent influence cards in the opponent influence zone;
conducting an opponent action phase, comprising:
activating, by the opponent, at least one card from the opponent hand by disposing the at least one card from the opponent hand onto the game surface, comprising at least one of:
activating an opponent champion card, wherein the opponent champion card comprises an opponent champion activation cost indicating a required number of influence cards to activate the opponent champion card;
activating an opponent location card, wherein the opponent location card comprises an opponent location activation cost indicating a required number of influence cards to activate the opponent location card; or
activating an opponent spell card, wherein the opponent location card comprises an opponent spell activation cost indicating a required number of influence cards to activate the opponent spell card,
wherein a total of at least one of the opponent champion activation cost, the opponent location activation cost, and the opponent spell activation cost is equal to or less than the total number of opponent influence cards in the opponent influence zone;
playing, by the opponent, an active opponent card activated in a previous turn, wherein the active card comprises an active opponent champion, wherein the playing the active opponent champion comprises at least one of causing the active opponent champion to raid the first player or attack the raiding active player champion; and
disposing the active opponent champion in the exhausted position to indicate the exhausted status; and
conducting, by the first team, a second player turn of the game, comprising:
readying, by the first player, the active player champion by disposing the active player champion from the exhausted position to a ready position to indicate a ready status.

2. The method of claim 1, further comprising collecting, by the first player, the victory points disposed on the active player champion in response to the readying the active player champion during the second player turn.

3. The method of claim 2, wherein the playing the active opponent champion comprises attacking the raiding active player champion, wherein the first opponent turn further comprises:
removing victory points from the raiding active player champion equal to the champion raid value of the attacking active opponent champion;
comparing the champion attack value of the attacking active opponent champion with the champion attack value of the raiding active player champion; and
in response to the champion attack value of the attacking active opponent champion being lower than the champion attack value of the raiding active player champion, discarding the attacking active opponent champion, or in response to the champion attack value of the attacking active opponent champion being greater than the champion attack value of the raiding active player champion, discarding the raiding active player champion.

4. The method of claim 3, further comprising collecting, by the first player, the remaining victory points disposed on the active player champion after the removing the victory points from the raiding active player champion equal to the champion raid value of the attacking active opponent champion in response to the readying the active player champion during the second player turn.

5. The method of claim 1, wherein the playing the active opponent champion comprises causing the active opponent champion to raid the first player, wherein the method further comprises:
disposing a number of victory points on the raiding active opponent champion equal to the champion raid value for the raiding active opponent champion.

6. The method of claim 1, wherein the conducting the first opponent turn further comprises:
playing, by the opponent, an active opponent card comprising an active opponent spell, wherein the spell effect of the active opponent spell causes readying the active player champion to occur before the conducting the second player turn, and
in response, the victory points disposed on the active player champion are discarded.

7. The method of claim 1, further comprising, before conducting the first player turn:
drawing, by the first player, a number of player cards from the player card deck to create the player hand; and
drawing, by the opponent, a number of opponent cards from the opponent card deck to create the opponent hand.

8. The method of claim 1, further comprising, before conducting the first player turn:
presenting, by the first player, a player main character card comprising a player character effect and a player character power cost; and
presenting, by the opponent, an opponent main character card comprising an opponent character effect and an opponent character power cost.

9. The method of claim 1, wherein the activating the at least one card from the player hand comprises, in response to the total number of player influence cards in the player influence zone being greater than or equal to the sum of the player champion activation cost and the player location activation cost, activating the player champion card and the activating the player location card.

10. The method of claim 1, wherein the activating the at least one card from the player hand comprises, in response to the total number of player influence cards in the player influence zone being greater than or equal to the sum of the player champion activation cost, the player location activation cost, and the player spell activation cost, activating the player champion card, activating the player location card, and activating the player spell card.

11. The method of claim 1, further comprising disposing, by the first player, a number of the total number of player influence cards equal to the total of at least one of the player champion activation cost, the player location activation cost, and the player spell activation cost into the exhausted position to indicate the exhausted status in response to the activating the at least one card from the player hand.

12. The method of claim 1, further comprising:
as part of the activating the at least one card from the player hand, activating a player overlay card from the player hand; and
disposing the player overlay card on the active player champion, wherein the player overlay card increases at least one of the champion attack value or the champion raid value of the active player champion.

13. The method of claim 12, wherein the player overlay card comprises an overlay value, wherein each champion card of the at least one champion card comprises a statistic comprising an overlay allowance, wherein the overlay value of the player overlay card disposed on the active player champion is less than or equal to a player overlay allowance of the active player champion.

14. The method of claim 1, wherein the first team comprises at least two players, and wherein the opposing team comprises a number of opponents equal to the at least two players on the first team, and wherein each player of the at least two players on the player team conducts a respective first player turn simultaneously, and wherein each opponent of the opposing team conducts a respective first opponent turn simultaneously.

15. The method of claim 1, wherein the conducting the player action phase further comprises:
playing, by the first player, an active player card comprising an active player location card;
effectuating the location effect of the active player location card; and
disposing the active player location card in the exhausted position to indicate the exhausted status.

16. The method of claim 15, further comprising, as part of the second player turn:
readying, by the first player, the active player location by disposing the active player location from the exhausted position to the ready position to indicate the ready status.

17. The method of claim 8, wherein the conducting the player action phase further comprises:
playing, by the first player, the player main character effect;
effectuating the player main character effect; and
disposing the player main character card in the exhausted position to indicate the exhausted status.

18. A system comprising:
a user device comprising a display screen;
a processor operably connected to the user device; and
a tangible non-transitory computer readable memory configured to communicate with the processor, the tangible non-transitory computer readable memory having instructions stored thereon that, in response to execution by the processor causes the processor to perform operations comprising:
presenting, by the processor, a player digital main character card on a graphical user interface (GUI), wherein the player digital main character card comprises a player main character effect and a player main character power cost;
presenting, by the processor, an opponent digital main character card on the GUI, wherein the opponent digital main character card comprises an opponent main character effect and an opponent main character power cost;
conducting, by the processor, a first player turn of a game for a first player on a first team, comprising:
drawing, by the processor and a random number generator, a digital card from a player digital card deck and presenting the drawn digital card as part of a player digital hand on the GUI, wherein the player digital card deck is presented facedown on the GUI, wherein the player card deck comprises 20 to 60 digital cards including at least one digital champion card, at least one digital location card, and at least one digital spell card, wherein the player digital card deck further comprises at least one digital overlay card, wherein the digital overlay card is at least partially transparent and is configured to be disposed over at least a portion of the at least one digital champion card, wherein the digital overlay card comprises at least one component that aligns with at least one component of the at least one digital champion card in response to being disposed over the at least one digital champion card;
wherein each digital champion card of the at least one digital champion card has champion statistics associated therewith comprising a champion activation cost, a champion attack value, and a champion raid value,
wherein each digital location card of the at least one digital location card comprises a location activation cost and a location effect, wherein the location effect affects at least one of a status of an active digital champion card of the first player or an opponent on an opposing team, a champion statistic of an active digital champion card of the first player or the opponent, victory points associated with the first player or the opponent, or a number of digital cards in the player digital hand or an opponent digital hand of the opponent, and
wherein each digital spell card of the at least one digital spell card comprises a spell activation cost and a spell effect, wherein the spell effect affects at least one of the status of an active digital champion card of the first player or the opponent, a champion statistic of an active digital champion card of the first player or the opponent, victory points associated with the first player or the opponent, or a number of digital cards in the player digital hand or the opponent digital hand;
presenting, by the processor and the random number generator, an additional player digital influence card facedown from the player digital card deck in a player influence zone of the GUI;
determining, by the processor, a total number of player digital influence cards in the player influence zone including the additional player digital influence card;
conducting, by the processor, a player action phase, comprising:
receiving, by the processor, a selection of at least one digital card from the player digital hand to activate;
activating, by the processor, the at least one digital card by removing the at least one digital card from the player digital hand and presenting the at least one digital card faceup on the GUI, comprising at least one of:
activating, by the processor, a player digital champion card, wherein the player digital champion card comprises a player champion activation cost indicating a required number of digital influence cards to activate the player digital champion card;
activating, by the processor, a player digital location card, wherein the player digital location card comprises a player location activation cost indicating a required number of digital influence cards to activate the player digital location card; or
activating, by the processor, a player digital spell card, wherein the player digital spell card comprises a player spell activation cost indicating a required number of digital influence cards to activate the player digital spell card,
wherein the processor confirms that a total of at least one of the player champion activation cost, the player location activation cost, and the player spell activation cost is equal to or less than the total number of player digital influence cards in the player influence zone in order to perform the activating the at least one digital card;
receiving, by the processor, a selection of an active player digital card presented on the GUI that was activated in a previous turn;
playing, by the processor, the selected active player digital card, wherein the selected active player digital card comprises an active player digital champion, wherein the playing the active player digital champion comprises causing the active player digital champion to raid the opponent;
associating, by the processor, a number of victory points with the raiding active player digital champion equal to the champion raid value for the raiding active player digital champion; and
disposing, by the processor, the raiding active player digital champion in an exhausted position on the GUI to indicate an exhausted status;
conducting, by the processor, a first opponent turn of the game for an opponent on an opposing team, comprising:
drawing, by the processor and the random number generator, a digital card from an opponent digital card deck and presenting the drawn digital card as part of the opponent digital hand for the opponent, wherein the opponent digital card deck is presented facedown on the GUI, wherein the opponent digital card deck comprises 20 to 60 digital cards including at least one digital champion card, at least one digital location card, and at least one digital spell card, wherein the opponent digital card deck further comprises at least one digital overlay card, wherein the at least one digital overlay card is at least partially transparent and is configured to be disposed over at least a portion of the at least one digital champion card, wherein the at least one digital overlay card comprises at least one component that aligns with at least one component of the at least one digital champion card in response to being disposed over the at least one digital champion card,
presenting, by the processor and the random number generator, an additional opponent digital influence card facedown from the opponent digital card deck in an opponent influence zone of the GUI;
determining, by the processor, a total number of opponent digital influence cards in the opponent influence zone including the additional opponent digital influence card;
conducting, by the processor, an opponent action phase, comprising:
receiving, by the processor, a selection of at least one digital card from the opponent digital hand to activate;
activating, by the processor, the at least one digital card by presenting the at least one digital card from the opponent digital hand faceup on the GUI, comprising at least one of:
activating, by the processor, an opponent digital champion card, wherein the opponent digital champion card comprises an opponent champion activation cost indicating a required number of digital influence cards to activate the opponent digital champion card;
activating, by the processor, an opponent digital location card, wherein the opponent digital location card comprises an opponent location activation cost indicating a required number of digital influence cards to activate the opponent digital location card; or
activating, by the processor, an opponent digital spell card, wherein the opponent digital spell card comprises an opponent spell activation cost indicating a required number of digital influence cards to activate the opponent digital spell card, p4 wherein the processor confirms that a total of at least one of the opponent champion activation cost, the opponent location activation cost, and the opponent spell activation cost is equal to or less than the total number of opponent digital influence cards in the opponent influence zone in order to perform the activating the at least one digital card;
receiving, by the processor, a selection of an active opponent digital card presented on the GUI that was activated in a previous turn;
playing, by the processor, the active opponent digital card, wherein the active opponent digital card comprises an active opponent digital champion, wherein the playing the active player opponent champion comprises at least one of causing, by the processor, the active opponent champion to raid the first player or attack the raiding active player digital champion; and/or
disposing, by the processor, the active opponent digital champion in the exhausted position to indicate the exhausted status; and
conducting, by the processor, a second player turn of the game, comprising:
readying, by the processor, the active player digital champion by disposing the active player digital champion from the exhausted position to a ready position on the GUI to indicate a ready status.

19. The system of claim 18, wherein the operations further comprise, before conducting the first player turn:
drawing, by the processor and the random number generator, a number of player digital cards from the player digital card deck to create the player digital hand;
presenting, by the processor, the number of player digital cards on the GUI for the player digital hand; and
drawing, by the processor and the random number generator, a number of opponent digital cards from the opponent digital card deck to create the opponent digital hand.

20. The system of claim 18, wherein the operations further comprise, assigning, by the processor, the victory points associated with the active player digital champion to the first player in response to the readying the active player digital champion during the second player turn.
